(19) United States
(12) Patent Application Publication
(10) Pub. No.: US 2026/0329979 A1
(43) Pub. Date: Oct. 22, 2026

(54) DYNAMIC GEOSPATIAL DNS WITH DRM CAPABILITIES

(71) Applicant: Metaverse Rights, Inc., Los Angeles, CA (US)

(72) Inventors: Guido Cugi, Cupertino, CA (US); Neil Mandt, Los Angeles, CA (US)

(21) Appl. No.: 19/651,373

(22) Filed: Apr. 17, 2026

Related U.S. Application Data
(60) Provisional application No. 63/790,533, filed on Apr. 17, 2025.

(51) Int. Cl. G06F 21/10

(52) U.S. Cl. CPC G06F 21/107

(57) ABSTRACT

Provided is a method including obtaining a set of geospatial coordinates based on at least one of user gaze data and pose data obtained from an extended reality device, determining a spatial target region in a physical environment based on the geospatial coordinates, determining one or more candidate entries of a hierarchical geospatial registry based on the spatial target region, determining that providing endpoint data associated with at least one of the one or more candidate entries to the extended reality device is permitted, and providing at least one of endpoint data, license data, authentication data, preview data, or reduced metadata associated with the one or more candidate entries to the extended reality device.

### CROSS-REFERENCE TO RELATED APPLICATIONS

This patent claims the benefit of U.S. Provisional Patent Application 63/790,533, filed Apr. 17, 2025, titled DYNAMIC GEOSPATIAL DNS WITH DRM CAPABILITIES. The entire content of the afore-listed patent filing is hereby incorporated by reference for all purposes.

### BACKGROUND

### 1. Field

The present disclosure relates generally to geographic information systems and, more specifically, to a dynamic geospatial domain name service (DNS) digital rights management (DRM) service.

### 2. Description of the Related Art

Extended reality (XR) platforms are increasingly incorporating real-time contextual awareness to deliver location-specific services, media, and user interactions. XR devices, such as smart glasses and headsets, often rely on a combination of positioning systems, gaze detection, and environmental sensing to infer user intent and surroundings. In many cases, these platforms may dynamically identify the user's current viewpoint or trajectory and initiate digital interactions based on that spatial context. To support such interactions, digital ecosystems may use spatial data to resolve content endpoints and negotiate access to services. This often involves identifying what content is permitted to be accessed or rendered at a given geographic location, sometimes in relation to user-specific attributes or device capabilities.

### SUMMARY

The following is a non-exhaustive listing of some aspects of the present techniques. These and other aspects are described in the following disclosure.

Some aspects include a method including obtaining a set of geospatial coordinates based on at least one of user gaze data and pose data obtained from an extended reality device, determining a spatial target region in a physical environment based on the geospatial coordinates, determining one or more candidate entries of a hierarchical geospatial registry based on the spatial target region, determining that providing endpoint data associated with at least one of the one or more candidate entries to the extended reality device is permitted, and providing at least one of endpoint data, license data, authentication data, preview data, or reduced metadata associated with the one or more candidate entries to the extended reality device.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example operating environment in which an extended reality device is directed toward a physical object and communicates with a computer system.

FIG. 2 illustrates an example method for determining and providing location-associated data in an extended reality environment.

FIG. 3 illustrates an example sequence diagram for location-based content retrieval in an extended reality environment.

FIG. 4 illustrates an example of a computing device upon which the processes described herein may be executed and with which the systems described herein may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some embodiments just as importantly, recognize problems overlooked (or not yet foreseen) by others in the fields of extended reality geographic information systems. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Many location-based digital services typically rely on static identifiers like uniform resource locators (URLs), quick response (QR) codes, or near-field communication (NFC) tags. These approaches, in many cases, lack scalability and real-time adaptability in immersive XR environments, where users require context-aware content linked to precise geospatial coordinates, which is not to suggest that these approaches are disclaimed or disavowed.

Additionally, there is generally no standardized mechanism to securely manage multiple application providers offering services at the same physical location, nor a unified framework to enforce digital rights management (DRM), which is not to suggest that embodiments are limited to approaches that address all of these needs. Indeed, many approaches provide only ad hoc ways to confirm location-based usage rights, leading to fragmentation and significant privacy, security, and licensing challenges. As XR adoption grows, legacy methods become even less effective, which is not to suggest that these approaches are disclaimed or disavowed. Embodiments are not limited to systems that address any or all of these problems, which is not to suggest that any other feature described herein is limiting.

To mitigate these or other issues, some embodiments afford a dynamic, geospatial coordinate–based content resolution system that securely verifies and enforces usage rights, allowing multiple service providers to coexist at a single location without sacrificing user experience or compliance.

For example, as the user walks down the street wearing XR glasses, the device typically provides real-time augmentation of the surrounding environment. When the user focuses on a specific location—such as a building façade—the glasses, in some embodiments, trigger content rendering based on that point of interest.

In some embodiments, the relative geospatial coordinates, calculated from the user's position and gaze direction, may be sent to a service called the Dynamic Geospatial DNS DRM service (or other types of geospatial resolver). This service, in some embodiments, resolves the coordinates into an appropriate endpoint (e.g., a network address, or resource, like content for presentation in association with the location and gaze direction, at the network address), which then, in some embodiments, initiates advanced protocol negotiations such as authentication and secure content retrieval.

To provide for this flow, application providers may, in some embodiments, first register their applications with the Dynamic Geospatial DNS DRM service. This registration may ensure that the XR glasses are able to discover and access the correct endpoints associated with the target location.

The service, in some embodiments, supports multiple application providers per location, providing for a variety of services to be mapped to the same geospatial coordinates. It also, in some embodiments, continuously (e.g., periodically with an industry acceptable cadence) verifies that each registered application holds valid digital rights to perform digital operations and transactions at the specified location.

Some embodiments provide for a Dynamic Geospatial DNS DRM Service—an integrated system that, in some embodiments, dynamically resolves geospatial coordinates (and in some cases, a user gaze vector) into service endpoints, enforces digital rights management (DRM), and supports multiple application providers at the same physical location. The platform leverages, in some embodiments, XR equipped with real-time positioning and gaze-tracking capabilities to detect precise user viewpoints. When a user wearing XR glasses focuses on a building façade or other point of interest, the device, in some embodiments, calculates relative coordinates and queries the Dynamic Geospatial DNS DRM Service.

Extended reality devices may require response times in the tens of milliseconds to maintain seamless user experiences, as delays in content rendering relative to user movement or gaze changes may cause perceptual discontinuities or reduce the effectiveness of spatial augmentation. Coordinate resolution involving distributed registries, rights verification, authentication preparation, and endpoint determination may introduce latencies that exceed these timing requirements when performed using conventional request-response patterns. In some embodiments, where coordinate-to-endpoint mappings are maintained using blockchain-based or decentralized consensus mechanisms, the timing mismatch may be particularly pronounced, as blockchain consensus operations may require seconds to minutes to complete while extended reality rendering operates on frame-rate timescales. This timing disparity creates a technical barrier that is not addressed by simply applying conventional processing techniques to the coordinate-resolution problem.

Routine or conventional approaches to coordinate-based content resolution may be insufficient to meet the latency requirements of extended reality interaction. For example, standard request-response patterns that wait for authoritative results before providing any response data, serial processing of coordinate lookups through hierarchical registries, establishing new secure communication sessions for each coordinate-resolution request, and relying solely on centralized or blockchain-based authoritative sources may each introduce latencies incompatible with extended reality interaction requirements. In some embodiments, blockchain consensus mechanisms in particular may operate on timescales that are orders of magnitude slower than extended reality frame rates, such that a system relying exclusively on blockchain-based authoritative resolution may be unable to provide response data within the latency budgets required for seamless spatial augmentation.

To address these timing constraints, some embodiments may employ one or more techniques that decouple the timing of authoritative resolution from the timing of response delivery to the extended reality device. In some embodiments, pre-computation and caching of coordinate-to-endpoint mappings for candidate regions may allow resolution to complete before user attention is confirmed, such that response data is available immediately when a spatial target region is identified. In some embodiments, hierarchical indexing of the geospatial registry may narrow the search space without requiring full registry traversal for each request. In some embodiments, edge-based provisional resolution using cached registry data or models trained to approximate registry behavior may provide preliminary response data while authoritative confirmation proceeds in parallel. In some embodiments, speculative parallel queries for ambiguous or adjacent coordinate ranges may reduce perceived latency when gaze or pose data does not yet distinguish among multiple candidate targets. In some embodiments, connection pooling may avoid repeated session establishment overhead by maintaining pre-negotiated secure communication sessions that can be reused across multiple coordinate-resolution requests.

These techniques may allow the system to provide response data within latency budgets suitable for extended reality rendering while still supporting distributed or decentralized registry architectures that provide resilience, redundancy, or community governance. In some embodiments, provisional results may be provided immediately from edge resources or local caches while authoritative confirmation from a centralized service, distributed registry, or blockchain-based network proceeds in parallel, and the provisional results may later be confirmed, replaced, or updated based on the authoritative result. In some embodiments, pre-computation for predicted regions of interest—determined from user velocity, heading, gaze patterns, or motion trajectory models—may allow resolution to complete before user attention is confirmed, thereby shifting latency-sensitive operations earlier in time relative to the moment of content presentation. Accordingly, some embodiments may address the timing mismatch between extended reality interaction requirements and distributed or decentralized registry architectures through a combination of predictive processing, caching, provisional resolution, and parallel query techniques.

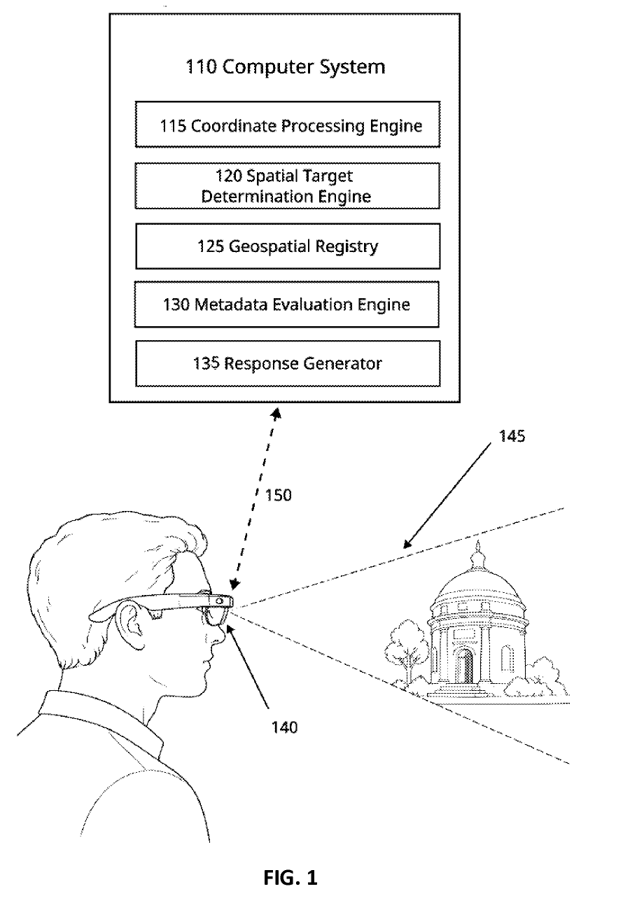

FIG. 1 depicts an example operating environment 100 in which a computer system 110 communicates with an extended reality device 140 over a communication link 150. The extended reality device 140 may be positioned within a physical environment and may be directed toward a viewed object or target region located within that physical environment. A field of view 145 of the extended reality device 140 may represent a spatial area or viewing volume corresponding to the extent visible to the device. Viewing direction and device orientation, which are distinct from field of view, may also be relevant to determining user attention. In some embodiments, the computer system 110 may determine and provide location-associated data corresponding to the physical environment, the viewed object, the target region, or combinations thereof.

The extended reality device 140 may include a head-mounted display (such as smart glasses, augmented reality glasses, or a mixed reality headset) or another wearable or handheld device configured to present digital content relative to the physical environment. In some embodiments, the extended reality device 140 may include one or more outward-facing cameras, one or more inward-facing cameras, one or more eye-tracking sensors, one or more inertial sensors, one or more position sensors, one or more communication interfaces, and one or more display devices. The extended reality device 140 may obtain gaze data, pose data, image data, inertial measurement data, head orientation data, location data, or other sensor data during operation. Gaze data may indicate a direction of the user's eyes as determined by eye-tracking sensors within the device, such as inward-facing cameras or other sensors configured to track eye position and movement. Pose data may indicate the position and orientation of the extended reality device 140 itself, which may be specified by six degrees of freedom including three dimensions of location and three dimensions of orientation. Such data may be used locally by the extended reality device 140, transmitted to the computer system 110 over the communication link 150, or both.

The physical environment may include outdoor environments, indoor environments, buildings, landmarks, rooms, floors, walls, signs, objects, or other real-world features. The viewed object or target region may correspond to any physical object, structure, surface, bounded area, coordinate-defined area, or spatial region within the physical environment. In some embodiments, the extended reality device 140 may be directed toward the viewed object such that gaze data, pose data, or both correspond to a line of sight, field of regard, field of view 145, or other view direction associated with the viewed object. The viewed object may be stationary or moving and may occupy all or part of the field of view 145.

In some embodiments, the extended reality device 140 may determine or assist in determining geospatial coordinates associated with the viewed object or target region based on one or more of the gaze data, pose data, image data, inertial measurement data, head orientation data, or location data. Additionally or alternatively, the computer system 110 may determine the geospatial coordinates based on data received from the extended reality device 140. The communication link 150 may include any wired or wireless communication path and may support transmission of coordinate data, sensor data, requests, responses, metadata, endpoint data, or other information between the extended reality device 140 and the computer system 110.

The computer system 110 may receive data from the extended reality device 140 and may determine location-associated data corresponding to the physical environment, the viewed object, the target region, or combinations thereof. In some embodiments, the computer system 110 may receive one or more of geospatial coordinates, gaze data, pose data of the extended reality device 140, image data, inertial measurement data, head orientation data, location data, or other session data obtained by the extended reality device 140. Based on the received data, the computer system 110 may determine target-related information, identify data associated with one or more spatial regions, evaluate associated metadata, and prepare response data for transmission to the extended reality device 140 over the communication link 150.

The computer system 110 may include one or more computing devices, servers, cloud-based resources, edge resources, or distributed processing systems. In some embodiments, the computer system 110 may include multiple computing nodes arranged across one or more geographic locations or network locations. One or more portions of the computer system 110 may be implemented by a centralized server system, one or more edge computing devices, one or more virtual machines, one or more containerized services, or other processing resources. In some embodiments, functions attributed to the computer system 110 may be performed by a single computing device. In other cases, such functions may be distributed among multiple devices or services that exchange data with one another.

In some embodiments, the computer system 110 may include or correspond to a geospatial resolver configured to determine data associated with coordinate ranges or spatial regions represented in a geospatial registry. The geospatial resolver may receive data indicating a spatial target region, determine one or more candidate entries associated with that spatial target region, evaluate metadata associated with the one or more candidate entries, and determine response data to be returned to the extended reality device 140. In some embodiments, the response data may include endpoint data, preview data, reduced metadata, authentication data, license data, or combinations thereof. The computer system 110 may additionally or alternatively perform one or more preprocessing operations, qualification operations, or response-selection operations before returning the response data.

In some embodiments, the computer system 110 may be configured to operate in conjunction with one or more supporting resources, including data stores, registry services, caching services, edge services, or security services. For example, the computer system 110 may communicate with a geospatial registry, may access cached region mappings, may use one or more established communication sessions for receiving requests and providing responses, or may perform cryptographic operations associated with request and response handling. The arrangement shown in FIG. 1 is illustrative, and one or more functions attributed to the computer system 110 may be combined, separated, relocated, or otherwise arranged in different ways.

The coordinate processing engine 115 may obtain, receive, or determine geospatial coordinates based on gaze data, pose data, or both. In some embodiments, the coordinate processing engine 115 may obtain, receive, or determine geospatial coordinates within a time interval, such as within 500 milliseconds, within one second, within two seconds, or within another time interval suitable for the user session. The particular latency associated with coordinate processing may vary based on network conditions, processing resources, sensor data availability, caching state, or other factors. In some embodiments, the coordinate processing engine 115 may receive raw or partially processed data from the extended reality device 140 over the communication link 150 and may determine one or more coordinates corresponding to a viewed object, a target region, a point of fixation, a line of sight, or a predicted region of interest. The gaze data may indicate a direction of the user's eyes as determined by eye-tracking sensors within the extended reality device 140, such as inward-facing cameras or other sensors configured to track eye position and movement. The gaze data may include one or more gaze samples, a gaze vector, a vergence-derived focal distance, or a fixation point. The pose data may indicate a position and orientation of the extended reality device 140, specified by six degrees of freedom including three dimensions of location (such as x, y, and z coordinates in a world coordinate system) and three dimensions of orientation (such as roll, pitch, and yaw angles). The pose data may additionally or alternatively indicate head pose, device attitude, translational movement, rotational movement, or combinations thereof. In some embodiments, the coordinate processing engine 115 may combine gaze data and pose data to determine a world-space ray, view direction, or other spatial representation extending from the extended reality device 140 or an estimated eye position into the physical environment. The coordinate processing engine 115 may then determine one or more geospatial coordinates associated with an object, surface, region, or volume intersected by that spatial representation.

In some embodiments, the coordinate processing engine 115 may process image data, inertial data, position data, or other sensor data to determine world coordinates, target coordinates, or region coordinates. For example, the coordinate processing engine 115 may receive image frames captured by one or more outward-facing cameras of the extended reality device 140 and may use visual features in the image frames, alone or in combination with inertial measurements, to determine a device position, device orientation, or scene-relative location. The coordinate processing engine 115 may further use data from one or more inertial measurement units, satellite navigation system sensors (such as Global Positioning System (GPS), GLONASS, or Galileo sensors), depth sensors, eye-tracking sensors, simultaneous localization and mapping pipelines, or other positioning subsystems to refine spatial alignment between the extended reality device 140 and the physical environment. In some embodiments, the coordinate processing engine 115 may transform one or more device-local coordinates into world coordinates using a pose estimate of the extended reality device 140. In some embodiments, the coordinate processing engine 115 may determine target coordinates associated with a particular point or object within the physical environment. In some embodiments, the coordinate processing engine 115 may determine region coordinates associated with a bounded area, polygonal area, volumetric area, coordinate range, or other spatial extent. The coordinate processing engine 115 may also normalize, convert, translate, rotate, project, or otherwise transform coordinate information among coordinate systems, including device-relative coordinate systems, eye-relative coordinate systems, world coordinate systems, map coordinate systems, and registry coordinate systems.

The coordinate processing engine 115 may iteratively update coordinates during a user session as successive gaze samples, pose samples, or other sensor samples are obtained. In some embodiments, the coordinate processing engine 115 may receive a sequence of gaze-direction samples over time and may repeatedly update one or more coordinates based on changes in user attention direction. In some embodiments, the coordinate processing engine 115 may additionally receive successive position samples, orientation samples, inertial measurements, or image-derived motion estimates and may update previously determined coordinates in response to movement of the user, movement of the extended reality device 140, or changes in the physical environment. The iterative updates may occur continuously, periodically, at event-triggered intervals, or in response to one or more threshold conditions. For example, the coordinate processing engine 115 may update coordinates when a difference between successive gaze samples exceeds an angular threshold, when a dwell threshold is satisfied, when a fixation criterion is satisfied, when focal depth aligns with an expected object depth, or when movement of the extended reality device 140 changes a projected line of sight. In some embodiments, the coordinate processing engine 115 may maintain a current coordinate estimate together with one or more confidence values, historical samples, timestamps, or filtered estimates and may revise the current coordinate estimate as additional data becomes available.

In some embodiments, the coordinate processing engine 115 may determine coordinates corresponding to a present target and may additionally determine coordinates corresponding to an anticipated or predicted target. For example, the coordinate processing engine 115 may process a sequence of position samples, orientation samples, gaze samples, and inertial measurements to determine a velocity vector, an acceleration profile, a predicted heading, or a predicted attention direction. Based on this information, the coordinate processing engine 115 may determine a future spatial volume, a predicted region of interest, or one or more predicted coordinates associated with an upcoming viewed object or target region. The coordinate processing engine 115 may provide such present or predicted coordinates to the spatial target determination engine 120 for further processing. In some embodiments, the coordinate processing engine 115 may also provide associated timing data, confidence data, stability data, focal-depth data, or other qualifying information so that downstream components may distinguish between transient coordinate estimates and coordinate estimates that satisfy one or more triggering criteria.

In some embodiments, the coordinate processing engine 115 may determine coordinates using one or more spatial qualification operations before forwarding the coordinates for subsequent processing. For example, the coordinate processing engine 115 may determine a world-space view vector and may compare that vector against a scene model, depth map, mesh representation, voxel representation, or other representation of the physical environment. The coordinate processing engine 115 may determine whether a candidate point, object, or region is likely to be visible, partially occluded, or fully occluded. The coordinate processing engine 115 may further determine whether gaze depth, vergence-derived focal distance, or dwell time corresponds to a candidate object or coordinate-mapped region. In this manner, the coordinate processing engine 115 may reduce the number of coordinates passed to downstream components when available data suggests that user attention is not sufficiently directed to a candidate target. The particular operations performed by the coordinate processing engine 115 may vary across implementations, and one or more operations attributed to the coordinate processing engine 115 may additionally or alternatively be performed by other components of the computer system 110 or by the extended reality device 140.

The spatial target determination engine 120 may determine a spatial target region in the physical environment based on the geospatial coordinates provided by the coordinate processing engine 115. In some embodiments, the spatial target region may correspond to a point, an area, a volume, a coordinate range, an object-associated bounding region, a surface-associated region, or another spatial extent within the physical environment. The spatial target determination engine 120 may determine the spatial target region by comparing one or more geospatial coordinates, gaze-derived coordinates, pose-derived coordinates, or region coordinates to one or more spatial representations of the physical environment. In some embodiments, the spatial target determination engine 120 may determine a present spatial target region corresponding to current user attention. In some embodiments, the spatial target determination engine 120 may determine a projected or predicted spatial target region corresponding to anticipated user movement, anticipated user attention, or both. The spatial target determination engine 120 may provide the determined spatial target region to the geospatial registry 125 for subsequent candidate-entry determination.

In some embodiments, the spatial target determination engine 120 may determine the spatial target region based on current user attention represented by one or more gaze vectors, gaze rays, lines of sight, fields of regard, or fields of view 145 associated with the extended reality device 140. For example, the spatial target determination engine 120 may receive from the coordinate processing engine 115 one or more world-coordinate positions, one or more device orientations, and one or more gaze-direction samples, and may determine a target region intersected by a world-space view vector extending from an estimated eye position or device viewpoint. In some embodiments, the spatial target determination engine 120 may determine the spatial target region based on a vergence-derived focal distance, a fixation location, a dwell-qualified gaze location, or another attention-associated spatial indicator. The spatial target determination engine 120 may thereby distinguish among multiple possible targets lying along a similar viewing direction but at different depths or occupying different portions of the physical environment. In some embodiments, the spatial target determination engine 120 may determine that the spatial target region corresponds to only a portion of a larger physical structure, such as a facade region, a window region, a floor-specific region, a doorway region, or another localized area within a broader object or building.

In some embodiments, the spatial target determination engine 120 may determine the spatial target region based on predicted user movement, predicted heading, predicted attention direction, or combinations thereof. For example, the spatial target determination engine 120 may receive a sequence of position samples, orientation samples, gaze-direction samples, timestamps, and inertial measurements, and may determine a velocity vector, an acceleration profile, a projected heading, a projected attention direction, or a motion trajectory model associated with a user session. Based on such information, the spatial target determination engine 120 may determine a future spatial volume extending from a current user position along a projected path of movement or attention. The future spatial volume may include a frustum, a cone, a curved volume, a corridor, a path-aligned region, or another predicted spatial extent. The spatial target determination engine 120 may determine the spatial target region from the future spatial volume by selecting one or more regions, objects, or coordinate ranges that fall within the predicted extent and satisfy one or more additional criteria. In this manner, the spatial target determination engine 120 may determine a predicted region of interest before the user actually directs confirmed attention to that region.

The spatial target determination engine 120 may additionally refine or qualify the spatial target region using one or more visibility-related techniques. In some embodiments, the spatial target determination engine 120 may determine a world-space view vector and may evaluate a spatial model of the physical environment to determine whether a candidate region is visible from a user viewpoint. Such evaluation may include ray intersection testing, bounding volume hierarchy traversal, depth-buffer comparison, graphics-pipeline occlusion analysis, visibility-score computation, or combinations thereof. The spatial target determination engine 120 may determine whether one or more intervening objects are positioned between the user viewpoint and a candidate target and may classify the candidate target as visible, partially visible, or occluded. The spatial target determination engine 120 may also determine a visibility score based on a number of rays reaching the candidate target, an amount of visible screen-space area, sampling across a bounding volume, or other visibility-related measurements. The spatial target determination engine 120 may use such information to select one target region from among multiple candidate regions, to suppress selection of an occluded region, or to defer determination of a target region until sufficient visibility is detected.

In some embodiments, the spatial target determination engine 120 may further refine the spatial target region using temporal and attention-related qualifications. For example, the spatial target determination engine 120 may evaluate successive gaze samples to determine whether a gaze direction remains within an angular threshold for at least a dwell threshold. The spatial target determination engine 120 may determine whether a fixation criterion has been satisfied, whether a focal depth matches a depth associated with a candidate object or region within a tolerance, whether a user velocity permits a sufficient viewing opportunity, or whether a predicted exposure window exceeds a threshold duration. Where such criteria are not satisfied, the spatial target determination engine 120 may decline to finalize a candidate region, may defer downstream resolution activity, or may identify a lower-confidence target region. Where such criteria are satisfied, the spatial target determination engine 120 may determine that the spatial target region has sufficient confidence, visibility, and user-attention correlation for downstream processing. In some embodiments, the spatial target determination engine 120 may output the spatial target region together with one or more associated attributes, such as a confidence measure, a visibility measure, a focal-depth measure, a dwell-related measure, a predicted-arrival time, or an indication of whether the region corresponds to a present or predicted target.

The particular operations performed by the spatial target determination engine 120 may vary across implementations. In some embodiments, the spatial target determination engine 120 may operate primarily on presently observed coordinates and attention data. In some embodiments, the spatial target determination engine 120 may additionally or alternatively operate on predicted movement and predicted attention data to determine a future target region. In some embodiments, one or more of the techniques described with respect to visibility determination, occlusion analysis, predictive trajectory modeling, focal-depth matching, fixation analysis, dwell qualification, or velocity-based gating may be used in connection with determining, refining, qualifying, or predicting the spatial target region. One or more such operations may be performed by the spatial target determination engine 120 alone, in cooperation with the coordinate processing engine 115, or in cooperation with other components of the computer system 110.

The geospatial registry 125 may store entries associated with coordinate ranges or spatial regions within the physical environment. In some embodiments, an entry may correspond to a bounded geographic area, a volumetric region, a mapped object region, a floor-specific area, a room, a facade portion, an outdoor zone, or another spatial extent for which location-associated data is available. The entries may be keyed by absolute coordinates, relative coordinates, coordinate ranges, polygons, meshes, bounding volumes, or other spatial descriptors usable to associate a target location or target region with one or more stored records. In some embodiments, a coordinate range may be defined using a center point and a radius, such that the coordinate range corresponds to a circular or spherical region centered at the specified point. In some embodiments, a coordinate range may alternatively be defined using polygon vertices that specify an arbitrary boundary shape, such that the coordinate range corresponds to a polygonal region having edges connecting the specified vertices. Polygon-based boundaries may be used to represent irregular geographic areas, property boundaries, building footprints, or other spatial extents that do not conform to a circular or spherical shape. In some embodiments, an entry may include endpoint data and associated metadata, such as license status, expiration data, geographic restriction data, provider status, user-context constraints, device-context constraints, preview data, authentication-related data, or other data used in selecting a response for the extended reality device 140.

In some embodiments, the geospatial registry 125 may be hierarchical and may include parent region entries and child region entries arranged according to geographic containment, spatial subdivision, semantic subdivision, or combinations thereof. A parent region entry may correspond to a broader geographic or spatial extent, while one or more child region entries may correspond to narrower extents located within the broader extent. For example, a broader region may correspond to a city block, campus, building, parcel, or other large area, while child region entries may correspond to subareas within that broader region, such as a building face, a floor, a room, a storefront, or another localized portion. The hierarchy may include multiple levels, and candidate-entry determination may proceed by recursively traversing from a broader entry to increasingly localized entries whose associated coordinate ranges contain, intersect, or otherwise correspond to a spatial target region determined by the spatial target determination engine 120. In some embodiments, entries in the geospatial registry 125 may include fields such as a region identifier, a region name, a service name, and a coordinate range specification that may include latitude, longitude, and radius values or other boundary definitions. A service name may comprise a human-readable or descriptive name for the service or application experience associated with the entry, such as a sports overlay service, a historical information service, a walking tour service, or another named experience. An entry may also include an applications array listing one or more registered application providers, where each application provider entry may specify a provider identifier, a service name, an endpoint URL, and associated DRM parameters such as license status, expiration date, and geographic restrictions. In some embodiments, an entry may further include a child region entries array that recursively contains child region entries, thereby enabling representation of nested spatial hierarchies such as buildings containing floors, floors containing rooms, or other multi-level arrangements.

The geospatial registry 125 may include root entries corresponding to broader regions and nested entries corresponding to increasingly localized regions. In some embodiments, a root entry may correspond to a top-level geographic area, such as a municipality, district, campus, map tile, or other large-scale region from which further traversal begins. Child entries may then be arranged beneath the root entry in successive layers of localization. In some embodiments, multiple child entries may be associated with a single parent entry, and multiple branches of the hierarchy may be explored when a spatial target region overlaps more than one coordinate range or when multiple candidate regions remain viable. In some embodiments, overlapping entries may be permitted such that different entries correspond to different providers, different content experiences, different contextual conditions, or different physical layers occupying the same or similar coordinates. The geospatial registry 125 may therefore support one-to-many associations between a spatial region and candidate entries.

In some embodiments, the geospatial registry 125 may be stored locally, remotely, or in distributed form. For example, all or part of the geospatial registry 125 may reside in memory or storage associated with the computer system 110, may be maintained by one or more remote registry services, or may be partitioned across multiple computing nodes. In some embodiments, a local cache, an edge node, or another intermediate resource may store a subset of registry entries or provisional mappings corresponding to regions expected to be relevant to a current user session. In some embodiments, different portions of the hierarchy may be stored at different locations, such that broader entries are maintained at one service and more localized entries are maintained at another service. The arrangement of the geospatial registry 125 shown in FIG. 1 is illustrative, and one or more data structures, indices, caches, replicated stores, or distributed services may be used to provide the functionality attributed to the geospatial registry 125.

In some embodiments, coordinate-to-service mappings may be stored and shared across a decentralized or blockchain-based network instead of, or in addition to, a centralized geospatial resolver. Each node in such a network may maintain partial or full replicas of the registry, and extended reality devices may resolve locations by querying one or more nodes in the decentralized network. This approach may provide resilience to downtime or single points of failure and may support community governance of registry data. In some embodiments, consensus mechanisms may be used for updating registry entries across the network, such that changes to coordinate-to-endpoint mappings are propagated among participating nodes. The decentralized network may operate in conjunction with other registry arrangements described herein, and one or more portions of the geospatial registry 125 may be maintained using centralized services, distributed processing systems, decentralized networks, or combinations thereof.

In some embodiments, extended reality devices may resolve locations by querying one or more nodes in a peer-to-peer network rather than relying solely on a centralized geospatial resolver. Each node in such a peer-to-peer network may maintain partial or full replicas of the registry, and different nodes may store different portions of the coordinate-to-endpoint mappings depending on geographic relevance, storage capacity, or participation policies. This arrangement may provide resilience to downtime or single points of failure, as the unavailability of one node may be compensated by the availability of other nodes maintaining overlapping or equivalent registry data. In some embodiments, community governance mechanisms may be used to manage registry data, such that participants in the network may propose, review, or approve changes to coordinate-to-endpoint mappings according to established governance rules. Consensus mechanisms may be used for updating registry entries across the network, such that changes to coordinate-to-endpoint mappings, license statuses, or provider registrations are propagated among participating nodes in a manner that maintains consistency across the distributed registry. The peer-to-peer approach may operate in conjunction with other registry arrangements described herein, including centralized services, distributed processing systems, or hybrid configurations in which some registry data is maintained centrally while other registry data is maintained across a decentralized network.

In some embodiments, the geospatial registry 125 may support efficient candidate-entry determination through one or more spatial indexing and traversal techniques. For example, the geospatial registry 125 may maintain associations between region entries and coordinate ranges in a manner that allows the computer system 110 to compare a spatial target region against entries at successive hierarchy levels, discard non-matching branches, and identify one or more candidate entries associated with the spatial target region. The geospatial registry 125 may additionally support retrieval of entries based on present coordinates, predicted coordinates, or both. In this manner, the geospatial registry 125 may provide a structured repository from which the computer system 110 identifies candidate entries for later metadata evaluation and response generation.

Entries of the geospatial registry 125 may include endpoint data and associated metadata corresponding to coordinate ranges or spatial regions represented in the geospatial registry 125. In some embodiments, endpoint data may identify a network-accessible resource, service endpoint, application endpoint, content source, or other addressable destination from which the extended reality device 140 may obtain digital content, application data, preview data, authentication data, license data, or other response data associated with a spatial target region. The endpoint data may include one or more network addresses, uniform resource locators, service identifiers, application identifiers, resource locators, provider identifiers, or other data usable by the computer system 110 or the extended reality device 140 to access, request, or otherwise obtain location-associated content or functionality. In some embodiments, a provider identifier may comprise a unique identifier for an application provider, such as a reverse domain name identifier (e.g., "com.example.app"), that distinguishes the provider from other providers registered at the same or overlapping coordinate ranges. In some embodiments, a registry entry may include a single endpoint. In some embodiments, a registry entry may include multiple endpoints corresponding to different content types, different delivery modes, different application states, different providers, different levels of access, or different user/device contexts.

Associated metadata of a registry entry may specify one or more characteristics used by the computer system 110 to evaluate, filter, rank, qualify, or otherwise process candidate entries identified for a spatial target region. In some embodiments, the metadata may specify one or more of license status, expiration data, geographic restriction data, provider status, user-context constraints, or device-context constraints. License status may indicate whether content or functionality associated with the entry is currently available for delivery, conditionally available, unavailable, revoked, suspended, or otherwise subject to a license-related state. Expiration data may indicate an expiration time, validity interval, refresh interval, time-to-live value, or other temporal condition associated with the entry. Geographic restriction data may indicate one or more permitted areas, prohibited areas, boundary conditions, region-specific rules, or spatial limitations applicable to use of the endpoint data. Provider status may indicate availability, authorization, service health, subscription status, campaign status, or another provider-associated condition. User-context constraints may indicate conditions associated with a user session, such as an identity state, subscription state, permission state, interaction history, content preference, or another user-associated context. Device-context constraints may indicate conditions associated with the extended reality device 140 or another client device, such as device type, display capability, processing capability, sensor availability, communication state, security state, or rendering capability.

In some embodiments, the metadata may additionally include preview-related data, authentication-related data, resource-classification data, content-type data, confidence-related data, prioritization data, caching-related data, or other supporting information associated with the entry. For example, a registry entry may include preview data identifying a lightweight representation of content that may be returned in a speculative response or a partial response before endpoint data is fully used. A registry entry may include authentication-related data identifying one or more credentials, tokens, token types, certificate requirements, or other information associated with accessing a corresponding endpoint. A registry entry may include content-type data or resource-classification data indicating whether the endpoint corresponds to advertising content, informational content, historical content, interactive content, media content, analytics-related content, navigation-related content, or another category. A registry entry may also include prioritization or ranking data usable by the computer system 110 to select among multiple candidate entries that correspond to the same or overlapping spatial regions.

In some embodiments, registry entries may correspond to different providers, different application experiences, overlapping coordinate ranges, layered spaces, or different contextual states. For example, multiple entries may be associated with the same or similar coordinate range while corresponding to different providers that offer different extended reality experiences for a common physical location. Multiple entries may also correspond to different layers of a physical environment, such as an exterior region, an interior region, a floor-specific region, a room-specific region, an elevation-specific region, or another layered spatial arrangement. In some embodiments, one entry may correspond to a first application experience available under a first context, while another entry may correspond to a second application experience available under a second context for the same physical location. Contextual differences may be associated with time, user status, provider status, device capability, movement state, confirmed visibility, or another qualifying condition. Accordingly, the geospatial registry 125 may support one-to-many relationships between a coordinate range or spatial region and multiple entries representing alternative responses, where each entry may be associated with a distinct service name identifying the particular service or application experience offered by that entry.

In some embodiments, the computer system 110 may evaluate the contents of registry entries after determining one or more candidate entries associated with a spatial target region. Such evaluation may include determining whether a given entry is active, valid, contextually appropriate, spatially applicable, or otherwise suitable for further processing. The metadata evaluation engine 130 may compare metadata of different entries, determine whether endpoint data should be returned, determine whether reduced metadata or preview data should be returned instead of endpoint data, or determine whether no response should be returned for a particular entry. Because different entries may correspond to different providers, application experiences, or contextual states, the contents of the registry entries may allow the computer system 110 to tailor a response to a current user session while maintaining associations between physical locations and one or more possible digital resources.

The metadata evaluation engine 130 may determine, based on metadata associated with one or more candidate entries identified from the geospatial registry 125, whether endpoint data corresponding to a candidate entry should be provided to the extended reality device 140. In some embodiments, the metadata evaluation engine 130 may receive, for each candidate entry, endpoint data together with associated metadata describing one or more conditions, states, or constraints applicable to that entry. The metadata evaluation engine 130 may compare the metadata to one or more aspects of a current session, such as a current spatial target region, a current or predicted user location, a user-associated context, a device-associated context, a provider-associated state, or a temporal condition, and may determine whether the candidate entry remains suitable for continued processing. In some embodiments, the metadata evaluation engine 130 may determine that a candidate entry satisfies one or more applicable conditions and may allow endpoint data corresponding to that candidate entry to be provided. In some embodiments, the metadata evaluation engine 130 may determine that a candidate entry does not satisfy one or more applicable conditions and may withhold endpoint data, may select another candidate entry, or may determine a different type of response for transmission.

In some embodiments, the metadata evaluation engine 130 may evaluate one or more metadata fields such as license status, expiration data, geographic restriction data, provider status, user-context constraints, device-context constraints, or combinations thereof. For example, the metadata evaluation engine 130 may determine whether a license associated with a candidate entry is active, expired, suspended, revoked, or otherwise subject to a state affecting delivery of associated content or functionality. The metadata evaluation engine 130 may determine whether an applicable validity interval, expiration time, time-to-live value, or refresh requirement has been satisfied. The metadata evaluation engine 130 may determine whether a current or predicted spatial target region falls within a permitted geographic area or outside a prohibited area indicated by geographic restriction data. The metadata evaluation engine 130 may determine whether a provider associated with a candidate entry is currently available, authorized, subscribed, active, or otherwise in a state that permits further use of the candidate entry. The metadata evaluation engine 130 may also evaluate session-specific constraints, such as whether a user account, permission state, subscription state, preference state, device type, sensor capability, rendering capability, communication state, or security state corresponds to one or more conditions associated with the candidate entry.

The metadata evaluation engine 130 may determine whether to provide endpoint data, reduced metadata, preview data, authentication data, license data, or other response data associated with one or more candidate entries. In some embodiments, the metadata evaluation engine 130 may select among multiple response types based on the results of metadata evaluation rather than merely determining whether any response should be returned. For example, where metadata indicates that a candidate entry is sufficiently qualified for full use, the metadata evaluation engine 130 may determine that endpoint data should be included in a response. Where metadata indicates that a candidate entry is relevant but not yet fully qualified, the metadata evaluation engine 130 may determine that preview data, provider-identification data, content-type data, resource-classification data, authentication-related data, or other reduced metadata should be returned without including endpoint data. Where metadata indicates that a candidate entry is not suitable for use in a current context, the metadata evaluation engine 130 may determine that no response data corresponding to that entry should be returned. In some embodiments, the metadata evaluation engine 130 may rank or prioritize candidate entries and may select a first response type for a first candidate entry and a different response type for a second candidate entry.

In some embodiments, the metadata evaluation engine 130 may determine a partial response, a speculative response, or an authoritative response. A partial response may include a subset of data associated with a candidate entry while omitting one or more other data elements, such as omitting endpoint data while including preview data, provider-identification data, or authentication-related metadata. A speculative response may be determined where ambiguity remains regarding a current target, such as where multiple candidate entries correspond to adjacent or overlapping coordinate ranges, where a predicted target region has not yet become a confirmed target region, or where additional session data is expected to refine selection among candidate entries. In such cases, the metadata evaluation engine 130 may determine that a reduced or preliminary response should be returned pending later confirmation. An authoritative response may be determined after additional metadata evaluation, additional coordinate refinement, additional visibility qualification, or receipt of an authoritative registry result. In some embodiments, the metadata evaluation engine 130 may determine that a speculative or partial response should be replaced, supplemented, or updated by a later authoritative response.

The metadata evaluation engine 130 may operate in conjunction with other components of the computer system 110. For example, the metadata evaluation engine 130 may receive candidate entries determined by recursive traversal of the geospatial registry 125, may receive target-related information from the spatial target determination engine 120, and may provide a response-selection output to the response generator 135. In some embodiments, the metadata evaluation engine 130 may also use confidence values, visibility-related data, dwell-related data, focal-depth-related data, predicted-arrival information, velocity-related information, or other qualifying information in combination with metadata associated with the candidate entries. Thus, the metadata evaluation engine 130 may serve as an intermediate decision component that determines not only whether a candidate entry remains applicable to a current or predicted context, but also what form of response data should be prepared and returned to the extended reality device 140.

The response generator 135 may provide endpoint data and/or associated metadata to the extended reality device 140 over the communication link 150. In some embodiments, the response generator 135 may receive one or more response determinations from the metadata evaluation engine 130 and may assemble response data corresponding to one or more candidate entries identified from the geospatial registry 125. The response generator 135 may select data fields to include in a response based on whether a candidate entry has been qualified for full delivery, provisional delivery, partial delivery, speculative delivery, or another response state. In some embodiments, the response generator 135 may provide response data for a single candidate entry. In some embodiments, the response generator 135 may provide response data for multiple candidate entries associated with a common spatial target region, overlapping coordinate ranges, multiple providers, layered spatial regions, or multiple contextual states. The response generator 135 may format the response data for use by the extended reality device 140, may associate timestamps or confidence-related information with the response data, and may prepare the response data for immediate transmission or staged transmission.

In some embodiments, the response generator 135 may provide preview data, reduced metadata, provider-identification data, candidate-entry metadata, content-type data, authentication-related data, or other response data associated with one or more candidate entries. Preview data may include a lightweight representation of content, a simplified overlay description, an icon, a low-resolution asset, a content summary, or another preliminary representation usable by the extended reality device 140 before a fuller content retrieval operation occurs. Reduced metadata may include a subset of data associated with a candidate entry while omitting one or more fields, such as omitting endpoint data while providing provider-identification data, candidate-entry metadata, content-type data, resource-classification data, or authentication-related information. Provider-identification data may identify an application provider, content provider, platform, campaign source, or other entity associated with the candidate entry. Candidate-entry metadata may identify one or more attributes of a selected or provisionally selected candidate entry, such as a region identifier, a confidence measure, a prioritization value, a status indication, or a qualification state. Content-type data may indicate whether a candidate entry corresponds to advertising content, informational content, historical content, media content, interactive content, navigation content, analytics-related content, or another category. Authentication-related data may include one or more token identifiers, token types, certificate requirements, challenge data, authorization-related parameters, or other information usable in connection with later access to an endpoint.

The response generator 135 may provide different response types under different conditions. In some embodiments, where a candidate entry has been sufficiently qualified, the response generator 135 may provide endpoint data together with one or more associated metadata fields. In some embodiments, where a candidate entry has not yet been fully qualified, where ambiguity remains among multiple candidate entries, or where a provisional mapping has been used pending later confirmation, the response generator 135 may provide a partial response or a speculative response. Such a partial response or speculative response may include preview data, provider-identification data, candidate-entry metadata, content-type data, or authentication-related data while omitting endpoint data. In some embodiments, the response generator 135 may later provide a follow-on response that supplements, replaces, or confirms an earlier response. For example, the response generator 135 may first provide reduced metadata associated with a predicted spatial target region and may later provide endpoint data after further visibility qualification, further metadata evaluation, or receipt of an authoritative registry result. In some embodiments, the response generator 135 may determine that no response data should be returned for a given candidate entry and may instead omit that entry from a transmitted response.

The endpoint data may identify a network-accessible resource configured to provide digital content for rendering an extended reality output associated with the spatial target region. In some embodiments, the endpoint data may include a network address, uniform resource locator, service address, application endpoint identifier, resource locator, or other addressing information usable by the extended reality device 140 or another client device to contact a remote resource. The network-accessible resource may provide digital content, application data, interactive elements, media assets, preview assets, license information, authorization information, or combinations thereof corresponding to the spatial target region. In some embodiments, the extended reality device 140 may use the endpoint data to retrieve digital content for rendering an overlay, annotation, visual augmentation, interactive interface element, audio output, or other extended reality output relative to the physical environment. In some embodiments, the response generator 135 may provide endpoint data together with authentication-related data, license data, or authorization-related data so that the extended reality device 140 may use such additional data when contacting the network-accessible resource.

In some embodiments, the response generator 135 may support staged, predictive, or accelerated delivery behaviors. For example, where the spatial target determination engine 120 identifies a predicted region of interest, the response generator 135 may provide preview data, endpoint-related data, or authentication-related data associated with one or more predicted candidate entries before the extended reality device 140 directs confirmed attention to the corresponding spatial target region. In some embodiments, the response generator 135 may provide metadata-only responses for speculative coordinate-resolution requests, may provide reduced responses for high-velocity viewing scenarios, or may provide different response payloads depending on available bandwidth, device capability, or confidence in a selected candidate entry. In some embodiments, the response generator 135 may cooperate with secure communication logic of the computer system 110 to transmit encrypted response payloads, signed response payloads, or both. The particular data items and delivery sequences used by the response generator 135 may vary across implementations, and one or more operations attributed to the response generator 135 may additionally or alternatively be performed by other components of the computer system 110.

Determining candidate entries from the geospatial registry 125 may include recursively traversing parent region entries and child region entries beginning at a root region entry and descending through increasingly localized region entries. In some embodiments, the computer system 110 may begin with a broader region entry associated with a large spatial extent and may determine whether the spatial target region determined by the spatial target determination engine 120 falls within, intersects, or otherwise corresponds to a coordinate range associated with that broader region entry. When the spatial target region corresponds to the broader region entry, the computer system 110 may proceed to one or more child region entries associated with narrower spatial extents contained within the broader region entry. This process may continue across multiple hierarchy levels until one or more localized entries associated with the spatial target region are identified. In some embodiments, recursive traversal may be performed by the geospatial registry 125 itself, by logic associated with the computer system 110, or by a combination thereof.

Determining candidate entries may include comparing the spatial target region to coordinate ranges associated with entries at successive hierarchy levels. For example, at a first level, the computer system 110 may compare the spatial target region to coordinate ranges associated with one or more root region entries. At a next level, the computer system 110 may compare the spatial target region to coordinate ranges associated with child entries of a selected root region entry. At additional levels, the computer system 110 may continue to compare the spatial target region to coordinate ranges associated with increasingly localized entries, such as entries associated with subareas, object-specific regions, elevation-specific regions, floor-specific regions, room-specific regions, or other narrower spatial extents. In some embodiments, the comparison may involve determining whether all or part of the spatial target region is contained within a coordinate range, overlaps a coordinate range, intersects a boundary associated with a coordinate range, or satisfies another spatial relationship relative to the coordinate range. The computer system 110 may discard non-matching branches of the hierarchy and may continue traversal only through branches that remain spatially relevant to the spatial target region.

In some embodiments, determining candidate entries may include addressing overlapping coordinate ranges, multiple candidate entries, multiple providers, or multiple contextual matches. For example, two or more entries may correspond to the same or similar coordinate ranges while representing different providers, different application experiences, different content categories, different elevation layers, or different contextual states associated with the same physical location. In such cases, the computer system 110 may identify multiple candidate entries for later evaluation rather than selecting only a single entry at the traversal stage. In some embodiments, multiple branches of the hierarchy may remain active during traversal, and the computer system 110 may carry forward multiple candidate entries when ambiguity exists in the spatial target region, when overlapping coordinate ranges are present, or when more than one entry is spatially applicable. One or more such candidate entries may later be filtered, ranked, confirmed, or otherwise processed by the metadata evaluation engine 130. Thus, recursive candidate-entry determination may serve as a spatial narrowing process that reduces a broader hierarchy to one or more entries that remain relevant to a current or predicted spatial target region.

In some embodiments, the computer system 110 may additionally support speculative or provisional candidate-entry determination in connection with recursive traversal. For example, when gaze data, pose data, or predicted motion data suggests more than one plausible spatial target region, the computer system 110 may traverse multiple hierarchy branches associated with adjacent or overlapping coordinate ranges. In some embodiments, the computer system 110 may determine provisional candidate entries using cached registry data or one or more locally maintained mappings before receiving an authoritative result from the geospatial registry 125. The authoritative result may then confirm, replace, or update the provisional candidate entries. Accordingly, recursive candidate-entry determination may include authoritative traversal, speculative traversal, provisional traversal, or combinations thereof.

In some embodiments, the computer system 110 may receive an encrypted request payload and an encrypted session key in connection with processing data received from the extended reality device 140. The encrypted request payload may include geospatial coordinates, gaze data, pose data, session data, or other information associated with a coordinate-resolution request. The encrypted session key may be encrypted using a public key corresponding to the computer system 110 or another server-side component such that the encrypted session key is recoverable using a private key associated with the computer system 110. In some embodiments, the encrypted request payload and the encrypted session key may be received together in a common message or in related messages transmitted over the communication link 150.

The computer system 110 may decrypt the encrypted session key, decrypt the encrypted request payload using the decrypted session key, validate a digital signature associated with the request payload, encrypt a response payload, and generate a digital signature for the response payload. For example, the computer system 110 may use a private key to recover a symmetric session key from the encrypted session key and may use the recovered session key to decrypt the encrypted request payload. The computer system 110 may further validate a digital signature associated with the request payload to determine whether the request payload originated from an authorized source and whether the request payload has remained unaltered. In some embodiments, the computer system 110 may decline to process a request, may provide a limited response, or may request re-authentication when signature validation fails or when another security condition is not satisfied. After determining response data, the computer system 110 may encrypt a response payload using the session key or another key and may generate a digital signature for the response payload before transmitting the response payload to the extended reality device 140. In this manner, confidentiality and authenticity may be maintained for both request processing and response delivery.

In some embodiments, the cryptographic operations described herein may be implemented using elliptic curve cryptography (ECC), which may offer strong security with smaller key sizes and lower computational overhead compared to other asymmetric cryptographic approaches. For key exchange and encryption, the computer system 110 or the extended reality device 140 may use an Elliptic Curve Integrated Encryption Scheme (ECIES) or may use Elliptic Curve Diffie-Hellman (ECDH) to derive a shared secret, followed by a key derivation function such as HMAC-based Key Derivation Function (HKDF) to generate a symmetric session key. For digital signature generation and validation, the computer system 110 or the extended reality device 140 may use an Elliptic Curve Digital Signature Algorithm (ECDSA) or an Edwards-curve Digital Signature Algorithm (EdDSA), such as Ed25519, which may provide efficient signing and verification operations. For symmetric encryption of request payloads and response payloads, the computer system 110 or the extended reality device 140 may use an authenticated encryption cipher such as Advanced Encryption Standard-Galois/Counter Mode (AES-GCM). The use of ECC-based primitives may be suitable for resource-constrained devices, such as extended reality devices, where computational resources, power consumption, or communication bandwidth may be limited. Other cryptographic algorithms, key sizes, or protocol configurations may be used in different implementations.

In some embodiments, security operations may be performed in coordination with other functions of the computer system 110. For example, decryption and signature validation may occur before the coordinate processing engine 115 processes request contents, before the spatial target determination engine 120 determines a spatial target region, or before the geospatial registry 125 is queried for candidate entries. Similarly, response-payload encryption and response signing may occur after the metadata evaluation engine 130 determines a response type and after the response generator 135 prepares one or more response data elements for transmission. The particular cryptographic techniques used may vary across implementations, and one or more security operations may be performed by dedicated security logic, by one or more engines shown in FIG. 1, or by another component associated with the computer system 110.

After receipt of endpoint data, the extended reality device 140 may access a network-accessible resource identified by the endpoint data. In some embodiments, the endpoint data may include a network address, uniform resource locator, service identifier, application endpoint identifier, resource locator, or other addressing information that allows the extended reality device 140 to establish communication with a remote resource corresponding to a candidate entry selected by the computer system 110. The network-accessible resource may be operated by a content provider, an application provider, a media service, an analytics service, a rights-management service, or another remote system associated with the endpoint data. Access to the network-accessible resource may occur immediately after receipt of the endpoint data or at a later time, depending on user attention, device state, metadata evaluation results, predicted relevance, or other conditions.

In some embodiments, the extended reality device 140 may obtain digital content, preview content, or protected content from the network-accessible resource. The obtained content may include visual overlays, annotations, interactive objects, media assets, audio assets, user-interface components, navigation cues, or other digital content associated with the spatial target region. Preview content may include a lightweight or preliminary representation that is suitable for immediate presentation or staged rendering. Protected content may include content subject to authentication requirements, license checks, access restrictions, expiration conditions, geographic conditions, or other controls associated with the candidate entry. In some embodiments, the extended reality device 140 may use the obtained content to render an extended reality output relative to the physical environment, such as rendering an output anchored to the viewed object, aligned with a surface, associated with a coordinate-defined region, or otherwise presented in relation to the spatial target region.

The extended reality device 140 may provide authentication tokens, authorization tokens, or other credentials in connection with accessing the network-accessible resource. In some embodiments, the computer system 110 may include authentication tokens, authorization tokens, or other credential data in the response provided to the extended reality device 140 together with the endpoint data. The extended reality device 140 may receive and store such tokens for use when contacting the network-accessible resource identified by the endpoint data. For example, the computer system 110 may return authentication-related data, token-related data, license data, or other access-related information together with endpoint data, and the extended reality device 140 may include such information in one or more subsequent requests directed to the network-accessible resource. In some embodiments, the extended reality device 140 may present a bearer token, a signed token, a certificate-derived credential, session information, device credentials, user credentials, or other authorization data when requesting digital content associated with the endpoint. The network-accessible resource may then validate the received tokens or credentials and may determine whether to provide content, preview data, license information, or other protected material based on the validation result. In this manner, endpoint interaction may extend the resolver-side determination process into downstream content access, thereby allowing the extended reality device 140 to obtain and render content associated with a spatial target region while honoring access-related conditions associated with the selected candidate entry.

One or more components illustrated in FIG. 1 may be implemented as separate physical components, integrated components, logical modules, software services, firmware modules, hardware circuits, or distributed functionality executed across multiple devices or systems. For example, the coordinate processing engine 115, the spatial target determination engine 120, the geospatial registry 125, the metadata evaluation engine 130, and the response generator 135 may be implemented within a single computing device, across multiple cooperating computing devices, within one or more cloud-based services, within one or more edge systems, or across combinations thereof. In some embodiments, one or more portions of the computer system 110 may be instantiated dynamically, may be virtualized, may be containerized, or may otherwise be provided as executable logic operating on shared or dedicated processing resources.

Functions described with respect to a given component may additionally or alternatively be performed by another component. For example, operations described with respect to the coordinate processing engine 115 may, in some embodiments, be performed in whole or in part by the extended reality device 140, the spatial target determination engine 120, or another component of the computer system 110. Similarly, operations described with respect to the geospatial registry 125, the metadata evaluation engine 130, or the response generator 135 may be combined, subdivided, reordered, duplicated, or otherwise allocated among different components. Data may be exchanged among components through function calls, application programming interfaces, message passing, shared memory, one or more data stores, network communications, or other communication mechanisms.

The arrangement shown in FIG. 1 is illustrative, and other arrangements may be used. Additional components may be included, one or more illustrated components may be omitted, and one or more illustrated communication paths may be modified. In some embodiments, one or more functions described with respect to the computer system 110 may be performed locally at the extended reality device 140, remotely from the extended reality device 140, or by combinations of local and remote systems. Accordingly, FIG. 1 is provided as one example of an operating environment in which the described techniques may be carried out.

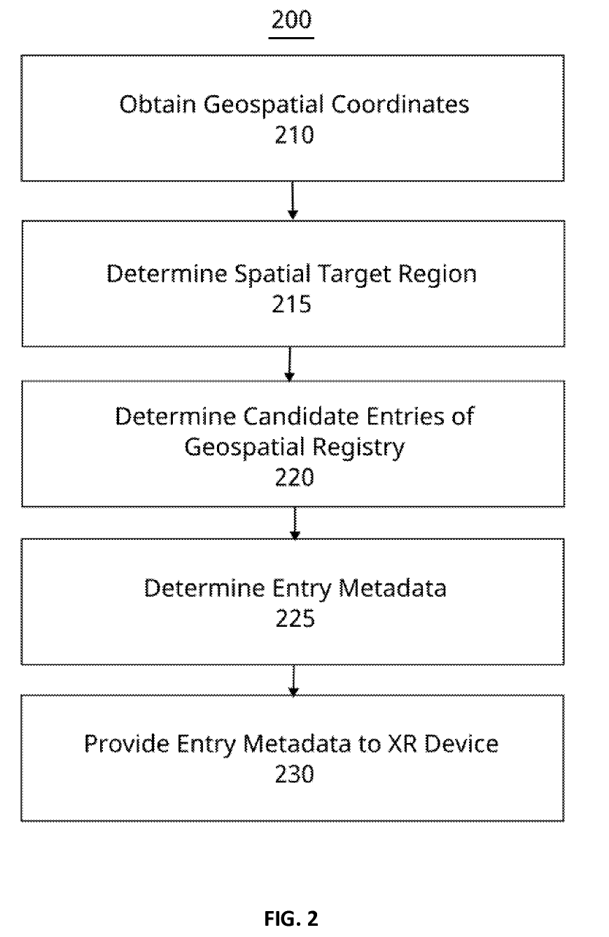

FIG. 2 illustrates an example method 200 for determining and providing location-associated data in an extended reality environment. In some embodiments, the method 200 may be used to associate gaze-based or pose-based input from an extended reality device with one or more spatial regions in a physical environment and to determine response data corresponding to those spatial regions. As shown, the method 200 may include an operation 210 for obtaining geospatial coordinates, an operation 215 for determining a spatial target region, an operation 220 for determining one or more candidate entries of a geospatial registry, an operation 225 for determining entry metadata, and an operation 230 for providing entry metadata to an extended reality device. The particular operations shown in FIG. 2 are illustrative and are presented at a high level for ease of explanation.

One or more operations of the method 200 may be performed by the computer system 110 of FIG. 1, the extended reality device 140, or combinations thereof. For example, in some embodiments, the extended reality device 140 may obtain or preprocess gaze data, pose data, image data, inertial data, or other sensor data, while the computer system 110 may determine a spatial target region, determine one or more candidate entries associated with the spatial target region, determine metadata associated with the one or more candidate entries, and determine response data to be returned to the extended reality device 140. In some implementations, one or more portions of the method 200 may be performed locally by the extended reality device 140, remotely by the computer system 110, or in a distributed manner across multiple devices or services.

The illustrated operations of the method 200 are examples and may be performed in different orders, combined, subdivided, omitted, repeated, or supplemented. For example, one or more qualification operations, visibility-related operations, prediction-related operations, speculative operations, security-related operations, or response-selection operations may be performed before, during, or after one or more of the illustrated operations. In some embodiments, one or more operations may be performed iteratively during a user session as additional gaze samples, pose samples, or other sensor data become available. Accordingly, FIG. 2 is intended to illustrate one example process flow for determining and providing location-associated data and is not intended to require a particular ordering, grouping, or exclusivity of operations.

At operation 210, geospatial coordinates may be obtained based on gaze data, pose data, or both. In some embodiments, the geospatial coordinates may correspond to a point, region, surface location, object-associated location, or coordinate-defined area within a physical environment. Obtaining the geospatial coordinates may include receiving from the extended reality device 140, one or more gaze samples, one or more pose samples, image data, inertial measurements, head-orientation data, position data, or other sensor data associated with a user session. The gaze data may indicate a direction of user attention, one or more gaze vectors, a fixation location, or another attention-associated spatial indicator. The pose data may indicate a position and orientation of the extended reality device 140, head pose, device attitude, translational movement, rotational movement, or combinations thereof. In some embodiments, the geospatial coordinates may be determined from the gaze data and the pose data by projecting a viewing direction into the physical environment and determining coordinates associated with a viewed object, viewed region, or point of interest. In some embodiments, a coordinate resolution request associated with the geospatial coordinates may include an application provider identifier that identifies the application or service requesting coordinate resolution. The application provider identifier may comprise a reverse domain name identifier, such as "com.example.app", or another unique identifier that distinguishes the requesting application from other applications that may be registered at the same or overlapping coordinate ranges.

In some embodiments, geospatial coordinates may be obtained without determining explicit latitude and longitude values. For example, the geospatial coordinates may be obtained by determining that a user is proximate to or viewing a physical feature associated with a particular identifier. In some cases, the extended reality device 140 or the computer system 110 may determine that a user is adjacent to a building with a known building identifier, may recognize a landmark or point of interest through image recognition, sensor data, or device-local mapping, or may reference an ontology of points of interest that associates named locations, structures, or features with spatial regions without requiring explicit coordinate values in a global coordinate system. Such an ontology may include identifiers for buildings, storefronts, monuments, transit stations, or other physical features, and the system may resolve a user's spatial context by matching sensor observations or environmental cues to entries in the ontology rather than by computing latitude and longitude. In some embodiments, the geospatial coordinates may be expressed as a reference to an entry in the ontology, as a building identifier together with a relative position or orientation, or as another spatial descriptor that does not depend on a traditional geographic coordinate system. The coordinate processing engine 115 or the extended reality device 140 may translate such alternative spatial descriptors into a form usable for subsequent spatial target determination and registry lookup.

Obtaining the geospatial coordinates may include processing image data, inertial measurements, and other sensor data from the extended reality device 140 to determine one or more world coordinates, target coordinates, or region coordinates associated with current or predicted user attention. For example, image frames captured by one or more outward-facing cameras may be used with inertial measurements, depth data, simultaneous localization and mapping outputs, or position data to determine a device viewpoint relative to the physical environment. The computer system 110, the extended reality device 140, or both may then determine one or more coordinates associated with a location intersected by a gaze-derived ray, a pose-derived line of sight, a field of view 145, or another spatial representation associated with the user session. In some embodiments, obtaining the geospatial coordinates may include transforming coordinate data among coordinate systems, including device-relative coordinates, eye-relative coordinates, world coordinates, map coordinates, and registry coordinates.

In some embodiments, obtaining the geospatial coordinates may include iteratively monitoring gaze data over time during a user session, determining successive gaze samples, and repeatedly updating the geospatial coordinates based on changes among the gaze samples. For example, successive gaze-direction samples may be compared to determine whether user attention remains directed toward a consistent spatial area or shifts toward another area in the physical environment. Successive pose samples, position samples, or inertial measurements may additionally be used to update previously determined coordinates in response to movement of the extended reality device 140 or movement of the user through the physical environment. The repeated updating may occur continuously, periodically, or in response to one or more threshold conditions, such as an angular deviation threshold, a fixation threshold, or another stability-related criterion. In this manner, operation 210 may produce geospatial coordinates that reflect a current or evolving attention state of the user rather than a single static sample.

Operation 210 may incorporate one or more gaze-related, vergence-related, dwell-related, and velocity-related techniques in connection with obtaining or refining the geospatial coordinates. In some embodiments, eye-tracking data may be used to determine a vergence-based focal depth associated with user gaze, and the geospatial coordinates may be refined based on whether the focal depth corresponds to a depth associated with a candidate object or region in the physical environment. In some embodiments, successive gaze samples may be evaluated to determine whether a dwell threshold or fixation criterion has been satisfied before the geospatial coordinates are treated as corresponding to a valid target. In some embodiments, velocity information derived from inertial data, position data, or other motion-related data may be used to determine whether a coordinate associated with a briefly viewed region should be maintained, updated, deprioritized, or withheld from later stages of processing. Accordingly, operation 210 may include not only receipt of raw coordinate-related data, but also one or more qualification operations by which gaze, pose, motion, and attention information are used to determine geospatial coordinates suitable for subsequent processing.

At operation 215, a spatial target region may be determined based on the geospatial coordinates obtained at operation 210. In some embodiments, the spatial target region may correspond to a point, area, volume, coordinate range, object-associated region, surface-associated region, or other spatial extent within the physical environment. The spatial target region may be determined by comparing one or more geospatial coordinates to one or more spatial representations of the physical environment, including a map representation, a scene model, a mesh representation, a voxel representation, a depth-aware model, a coordinate index, or another representation usable to associate coordinates with a physical object, a physical structure, or a bounded region. In some embodiments, determining the spatial target region may include selecting a region intersected by a gaze-derived ray, a pose-derived view direction, a field of view 145, or another spatial representation associated with the extended reality device 140. In some embodiments, the spatial target region may correspond to an entire object, a portion of an object, a facade region, a floor-specific region, a room-specific region, a bounded area adjacent to a structure, or another localized region within a broader physical environment.

The spatial target region may be a present target region corresponding to current user attention or a predicted target region corresponding to predicted user movement or attention direction. In some embodiments, a present target region may be determined from current gaze data, current pose data, current device position, or current head orientation, such that the spatial target region corresponds to a presently viewed object or area. In some embodiments, a predicted target region may be determined from projected movement of the user, a predicted heading, a predicted attention direction, or another forecast of where the user is likely to look or move. For example, position samples, orientation samples, gaze-direction samples, timestamps, and inertial measurements may be used to determine a velocity vector, an acceleration profile, a projected heading, or a motion trajectory model. Based on that information, a future spatial volume may be determined, such as a frustum, cone, corridor, or path-aligned volume extending from a current user position. The spatial target region may then be determined from one or more regions, objects, or coordinate ranges that fall within that future spatial volume. In this manner, operation 215 may determine not only a current target of attention, but also an anticipated target associated with predicted movement or predicted user attention.

Operation 215 may incorporate one or more occlusion-related, prediction-related, focal-depth-related, and visibility-related techniques in connection with determining, refining, or qualifying the spatial target region. In some embodiments, determining the spatial target region may include determining whether a candidate region is visible from a user viewpoint by determining a world-space view vector and evaluating a model of the physical environment using ray intersection testing, bounding volume hierarchy traversal, depth-buffer comparison, graphics-pipeline occlusion analysis, visibility-score computation, or combinations thereof. The method may include determining whether one or more intervening objects lie between the user viewpoint and a candidate target region and may include suppressing or deferring selection of a candidate region when the candidate region is classified as occluded or insufficiently visible. In some embodiments, determining the spatial target region may additionally include determining a vergence-based focal depth associated with user gaze, comparing that focal depth to a depth associated with a candidate object or candidate region, and favoring a target region whose depth corresponds to the focal depth within a threshold. In some embodiments, successive gaze samples may be evaluated to determine whether a dwell threshold, fixation threshold, or stability threshold has been satisfied before a candidate region is treated as the spatial target region. In some embodiments, velocity-related information may be used to determine whether a candidate region is likely to remain within view for a sufficient duration to justify continued processing. Accordingly, operation 215 may include not only a spatial mapping from coordinates to a region, but also one or more refinement or qualification operations by which present or predicted user attention is associated with a spatial target region suitable for subsequent registry traversal and metadata evaluation.

At operation 220, one or more candidate entries of a hierarchical geospatial registry may be determined based on the spatial target region determined at operation 215. In some embodiments, the spatial target region may be used as an input to a lookup process that identifies one or more registry entries associated with the same or a corresponding coordinate range, spatial region, object-associated region, elevation-specific region, or other spatial extent represented in the geospatial registry 125. The candidate entries may include entries that fully contain the spatial target region, partially overlap the spatial target region, intersect a boundary of the spatial target region, or otherwise satisfy a spatial relationship relative to the spatial target region. In some embodiments, determining the one or more candidate entries may include identifying entries associated with a present target region, a predicted target region, or both.

Determining the one or more candidate entries may include recursively traversing parent region entries and child region entries beginning at a root region entry and descending through increasingly localized region entries. For example, the method may begin at a root region entry corresponding to a broader geographic or spatial extent and may determine whether the spatial target region falls within, overlaps, or otherwise corresponds to a coordinate range associated with the root region entry. In response to determining that the spatial target region corresponds to the root region entry, the method may continue by evaluating one or more child region entries associated with narrower spatial extents contained within the broader extent represented by the root region entry. This recursive traversal may continue across multiple levels of the hierarchy until one or more sufficiently localized entries associated with the spatial target region are identified. In some embodiments, the recursive traversal may be depth-first, breadth-first, branch-pruned, or otherwise structured to narrow the search space as successive hierarchy levels are evaluated.

Determining the one or more candidate entries may include comparing the spatial target region to coordinate ranges associated with region entries at successive hierarchy levels. In some embodiments, the comparison may include determining whether all or part of the spatial target region is contained within a coordinate range, whether the spatial target region overlaps a coordinate range, whether a center point or representative point of the spatial target region lies within a coordinate range, or whether another spatial matching criterion is satisfied. At a first level, the method may compare the spatial target region to coordinate ranges associated with one or more broader entries. At a next level, the method may compare the spatial target region to coordinate ranges associated with narrower entries beneath a selected broader entry. At still further levels, the method may continue comparing the spatial target region to coordinate ranges associated with increasingly localized entries, such as entries corresponding to portions of a structure, floor-specific regions, room-specific regions, facade regions, or other localized spatial extents. In this manner, operation 220 may progressively narrow a large set of possible entries to one or more entries that remain spatially relevant to the spatial target region.

Determining the one or more candidate entries may include addressing overlapping coordinate ranges, multiple providers, multiple candidate entries, or multiple contextual matches. For example, two or more entries may correspond to the same or similar coordinate ranges while representing different providers, different application experiences, different resource types, different elevation layers, or different contextual states associated with the same physical location. In such cases, operation 220 may identify multiple candidate entries rather than selecting only a single entry at the traversal stage. In some embodiments, multiple hierarchy branches may remain active where the spatial target region corresponds to more than one coordinate range or where available data does not yet distinguish between adjacent or overlapping candidate areas. The method may then carry forward multiple candidate entries for later evaluation at operation 225, where associated metadata may be used to filter, rank, qualify, or otherwise distinguish among the candidate entries. Thus, operation 220 may serve as a spatial selection stage that preserves multiple plausible entries when further contextual or metadata-based evaluation remains to be performed.

In some embodiments, determining the one or more candidate entries may additionally include provisional or speculative handling during traversal. For example, when gaze data, pose data, or predicted movement data suggests more than one plausible spatial target region, the method may traverse multiple branches of the hierarchical geospatial registry in parallel or near-parallel to identify candidate entries associated with adjacent or overlapping coordinate ranges. In some embodiments, cached registry data or a provisional mapping may be used to identify one or more likely candidate entries before an authoritative traversal result is available. Such provisional candidate entries may later be confirmed, replaced, or updated based on an authoritative registry result. Accordingly, operation 220 may include authoritative traversal, speculative traversal, provisional candidate identification, or combinations thereof, depending on the configuration of the system and the available session data.

At operation 225, metadata associated with the one or more candidate entries may be determined. In some embodiments, after operation 220 identifies one or more candidate entries corresponding to the spatial target region, the method may include retrieving, accessing, or otherwise determining metadata stored in association with the candidate entries in the geospatial registry 125. The metadata may characterize one or more conditions, states, restrictions, or attributes associated with a candidate entry and may be used to determine whether the candidate entry remains applicable to a current or predicted context of the extended reality device 140. In some embodiments, metadata may be determined for a single candidate entry. In some embodiments, metadata may be determined for multiple candidate entries corresponding to overlapping coordinate ranges, multiple providers, layered spaces, or multiple contextual matches associated with the same or similar spatial target region.

The metadata may include one or more of license status, suspension reason, expiration data, geographic restriction data, provider status, user-context constraints, or device-context constraints. For example, license status may indicate whether content or functionality associated with a candidate entry is active, inactive, suspended, revoked, conditionally available, or otherwise subject to a license-related state. In some embodiments, when the license status indicates a suspended state, the metadata may further include a suspension reason indicating a cause of the suspension, such as a policy violation, a compliance issue, a rights-holder action, or another suspension-related condition. Expiration data may indicate an expiration time, a validity interval, a refresh interval, a time-to-live value, or another time-based condition associated with the candidate entry. Geographic restriction data may indicate one or more permitted areas, prohibited areas, coordinate boundaries, spatial conditions, or other location-based restrictions applicable to the candidate entry. Provider status may indicate whether a provider associated with the candidate entry is available, authorized, active, subscribed, healthy, or otherwise in a state compatible with further use of the candidate entry. User-context constraints may indicate one or more conditions associated with a current user session, such as identity state, subscription state, permission state, preference state, interaction history, or other user-associated context. Device-context constraints may indicate one or more conditions associated with the extended reality device 140 or another client device, such as device type, rendering capability, sensor capability, security state, communication capability, or processing capability.

In some embodiments, operation 225 may include determining, based on the metadata, whether endpoint data should be provided. For example, the method may include determining whether a candidate entry remains valid for a current or predicted spatial target region, whether one or more temporal conditions remain satisfied, whether a current or predicted location complies with one or more geographic restrictions, whether a provider associated with the candidate entry remains in a qualifying state, and whether user-associated or device-associated constraints are satisfied for the candidate entry. Where the metadata indicates that a candidate entry remains sufficiently qualified, the method may include determining that endpoint data associated with the candidate entry should be provided. Where the metadata indicates that one or more applicable conditions are not satisfied, the method may include determining that endpoint data should not be provided for that candidate entry, that another candidate entry should be selected instead, or that a reduced or alternative response should be provided. In some embodiments, determining whether endpoint data should be provided may include comparing metadata of multiple candidate entries and selecting one or more entries having metadata that most closely corresponds to a current or predicted context of the extended reality device 140.

The method may additionally include determining a type of response to be provided based on the metadata. In some embodiments, operation 225 may include determining whether to provide endpoint data, reduced metadata, preview data, authentication data, license data, provider-identification data, candidate-entry metadata, or another type of response data associated with one or more candidate entries. For example, when the metadata indicates that a candidate entry is fully qualified for downstream access, the method may include determining that endpoint data should be returned. When the metadata indicates that a candidate entry is potentially relevant but not yet fully qualified, the method may include determining that a reduced response should be returned, such as preview data, provider-identification data, content-type data, resource-classification data, authentication-related data, or another subset of information while omitting endpoint data. When the metadata indicates that no candidate entry is suitable for a present or predicted context, the method may include determining that no response should be returned for that candidate entry. In some embodiments, the method may determine different response types for different candidate entries associated with the same spatial target region.

In some embodiments, operation 225 may support staged response selection, including determination of a partial response, a speculative response, or an authoritative response. A partial response may include a subset of data associated with a candidate entry while excluding one or more other data elements, such as excluding endpoint data while including preview data or authentication-related metadata. A speculative response may be determined where ambiguity remains regarding a selected target region, where multiple candidate entries remain under consideration, or where a provisional mapping has been used pending later confirmation. An authoritative response may be determined after additional qualification has been completed, such as after further refinement of the spatial target region, additional visibility qualification, additional session data, or receipt of an authoritative registry result. Thus, operation 225 may include not only identifying metadata fields associated with candidate entries but also using those metadata fields to determine whether endpoint data should be provided and what form of response data should be prepared for operation 230.

At operation 230, response data may be provided to the extended reality device 140. In some embodiments, the response data may include endpoint data, license data, authentication data, preview data, reduced metadata, or other response data associated with one or more candidate entries identified at operation 220 and further processed at operation 225. The response data may be selected based on metadata associated with the candidate entries, a current or predicted spatial target region, a qualification state of the candidate entries, or combinations thereof. In some embodiments, response data may be provided for a single candidate entry. In some embodiments, response data may be provided for multiple candidate entries associated with overlapping coordinate ranges, multiple providers, multiple contextual states, or multiple plausible targets. The response data may be transmitted from the computer system 110 to the extended reality device 140 over the communication link 150 and may be formatted for immediate use, staged use, or later confirmation.

In some embodiments, operation 230 may include providing endpoint data, license data, authentication data, preview data, reduced metadata, or combinations thereof. Endpoint data may identify a network-accessible resource, service endpoint, application endpoint, content source, or other addressable destination associated with a candidate entry. License data may indicate one or more conditions associated with use of content or functionality corresponding to the candidate entry, such as validity information, access conditions, expiration-related information, or other license-associated parameters. Authentication data may include token-related data, credential-related data, certificate-related data, or other information usable by the extended reality device 140 when contacting a network-accessible resource identified by the endpoint data. Preview data may include a lightweight representation of content, a simplified overlay description, a low-resolution asset, a content summary, or another preliminary representation suitable for early or limited presentation. Reduced metadata may include a subset of data associated with a candidate entry while omitting one or more fields, such as omitting endpoint data while including provider-identification data, candidate-entry metadata, content-type data, resource-classification data, or authentication-related information.

In some embodiments, operation 230 may include providing a partial response or a speculative response. A partial response may include less than a full set of response data associated with a candidate entry and may be suitable where additional confirmation, additional qualification, or additional session data is expected before a fuller response is provided. For example, a partial response may include preview data, provider-identification data, candidate-entry metadata, content-type data, resource-classification data, or authentication-related data while omitting endpoint data. A speculative response may be provided where ambiguity remains with respect to the spatial target region, where multiple candidate entries remain under consideration, where a provisional mapping has been used pending later confirmation, or where the system predicts that a candidate entry will become relevant in the near future. In such cases, the partial response or speculative response may allow the extended reality device 140 to prepare for a possible future interaction while delaying fuller access information until additional confirmation is available. In some embodiments, a later response may supplement, replace, or confirm a previously provided partial response or speculative response.

The endpoint data may identify a network-accessible resource from which the extended reality device 140 obtains digital content for rendering an extended reality output associated with the spatial target region. In some embodiments, the endpoint data may include a network address, uniform resource locator, service identifier, application endpoint identifier, resource locator, or other addressing information usable by the extended reality device 140 to contact a remote resource. The remote resource may provide digital content, application data, interactive elements, media assets, preview assets, authorization data, license-related information, or other information associated with the spatial target region. After receiving the endpoint data, the extended reality device 140 may access the identified network-accessible resource and may use content obtained from the resource to render an overlay, annotation, visual augmentation, interactive element, audio output, or another extended reality output relative to the physical environment.

In some embodiments, operation 230 may include staged or selective delivery of response data. For example, the computer system 110 may first provide reduced metadata or preview data associated with a candidate entry and may later provide endpoint data after further metadata evaluation, further visibility qualification, further refinement of the spatial target region, or receipt of an authoritative registry result. In some embodiments, different response types may be provided for different candidate entries associated with a common spatial target region. In some embodiments, the response data may be encrypted, digitally signed, or otherwise prepared for secure transmission prior to being provided to the extended reality device 140. Accordingly, operation 230 may include not only transmitting data corresponding to one or more candidate entries, but also selecting a form, scope, timing, and delivery sequence of the response data based on the current state of processing associated with the spatial target region.

In some embodiments, the response data need not be provided directly to the extended reality device 140. Instead, the computer system 110 may provide at least some of the response data to a remote server configured to provide content to the extended reality device 140. The remote server may be separate from the computer system 110 that performs coordinate resolution, separate from the extended reality device 140, or separate from both. In some embodiments, the remote server may correspond to an application server, an application endpoint, a content-selection server, a media service, an orchestration service, a rendering-preparation service, a content delivery service, or another network-accessible resource configured to select, prepare, or provide content for presentation by the extended reality device 140.

In some embodiments, the response data provided to the remote server may include endpoint data, license data, authentication data, preview data, reduced metadata, provider-identification data, content-type data, candidate-entry metadata, resource-classification data, or combinations thereof. The remote server may use the response data to determine what content, if any, is to be provided to the extended reality device 140 for a current or predicted spatial target region. For example, the remote server may use endpoint data to identify one or more content sources, may use license data or authentication data to determine whether protected content is available for the current session, may use preview data or reduced metadata to select among multiple candidate content items, and may use content-type data, provider-identification data, or candidate-entry metadata to choose a content experience corresponding to a particular provider, application state, or contextual condition.

In some embodiments, the remote server may select content based on one or more characteristics of the response data without requiring the extended reality device 140 itself to perform the full selection logic. For example, the remote server may receive response data indicating that a first candidate entry is fully qualified for downstream access, that a second candidate entry is qualified only for preview delivery, or that a third candidate entry is not currently available. Based on that response data, the remote server may select one or more content items, one or more media assets, one or more rendering instructions, one or more user-interface elements, or one or more interaction definitions for delivery to the extended reality device 140. In some embodiments, the remote server may further obtain content from one or more additional network-accessible resources, may retrieve protected assets using authentication-related data, may confirm license-related conditions, may assemble a response package for the extended reality device 140, or may determine a staged sequence in which preview content is first provided and fuller content is later provided.

In some embodiments, the remote server may tailor content for the extended reality device 140 based on device-associated context, network conditions, timing constraints, or rendering capabilities indicated by the response data or otherwise available to the remote server. For example, the remote server may select a lower-latency content package, a lower-resolution asset, a progressive media stream, or a simplified overlay description when the extended reality device 140 is operating under constrained bandwidth, reduced processing availability, or a short predicted viewing opportunity. In some embodiments, the remote server may transcode, resize, reformat, segment, prioritize, rank, prefetch, cache, or otherwise prepare content before transmitting the content to the extended reality device 140. In some embodiments, the remote server may provide content directly to the extended reality device 140, may provide content through a content delivery network, or may provide content through one or more intermediate services that remain consistent with the response data determined by the computer system 110.

In some embodiments, the remote server may be constrained to provide content that is consistent with the response data received from the computer system 110. For example, where the response data indicates that only preview delivery is currently permitted, the remote server may provide preview content while refraining from providing full protected content. Where the response data indicates that a license state, geographic restriction, user-context constraint, or device-context constraint limits delivery, the remote server may select content consistent with that limitation, may omit disallowed content, may provide a substituted content item, or may provide an error indication or subscription prompt. In some embodiments, where later response data updates, confirms, supplements, or replaces earlier response data, the remote server may correspondingly update, replace, supplement, or withdraw content previously selected for the extended reality device 140.

In some embodiments, the computer system 110 may transmit response data both to the extended reality device 140 and to the remote server. For example, the extended reality device 140 may receive reduced metadata, preview data, or candidate-entry metadata for immediate user-interface preparation, while the remote server receives endpoint data, license data, authentication data, or other response data for use in selecting and preparing content to be delivered to the extended reality device 140. In some embodiments, the remote server may notify the extended reality device 140 that content consistent with the response data is available, may stream the selected content to the extended reality device 140, or may make the selected content available for retrieval by the extended reality device 140. In this manner, some embodiments may separate coordinate-resolution and rights-related decision logic from downstream content-selection and content-delivery logic while still causing the content ultimately presented by the extended reality device 140 to remain consistent with the response data determined for the spatial target region.

In some embodiments, one or more operations of the method 200 may be carried out using encrypted request and response handling. For example, obtaining the geospatial coordinates at operation 210 may include receiving, from the extended reality device 140, an encrypted request payload and an encrypted session key. The encrypted request payload may include one or more of geospatial coordinates, gaze data, pose data, image data, inertial measurements, head-orientation data, device identifiers, timestamps, session identifiers, or other information associated with a request to determine location-associated data. The encrypted session key may be encrypted using a public key corresponding to the computer system 110, a resolver service, or another server-side component such that the encrypted session key may be recovered using a corresponding private key.

In some embodiments, the method 200 may include decrypting the encrypted session key and decrypting the encrypted request payload using the decrypted session key. For example, the computer system 110 may use a private key to recover a symmetric session key from the encrypted session key and may then use the recovered session key to decrypt the encrypted request payload. The method 200 may further include validating a digital signature associated with the encrypted request payload or an underlying request message to determine whether the request originated from an authorized source and whether the request contents remained unaltered during transmission. In some embodiments, the method 200 may include declining to process the request, limiting a response, requesting additional authentication, or otherwise altering downstream processing when signature validation fails or when another security-related condition is not satisfied. In some embodiments, decryption and signature validation may occur before one or more of operations 210, 215, 220, 225, or 230 proceed using the received request contents.

In some embodiments, after determining response data for the extended reality device 140, the method 200 may include encrypting a response payload and generating a digital signature for the response payload before transmission. The response payload may include endpoint data, license data, authentication data, preview data, reduced metadata, or other response data associated with one or more candidate entries. The response payload may be encrypted using the session key or another key associated with the session, and the digital signature may be generated using a private key of the computer system 110 or another server-side component. The encrypted and signed response payload may then be transmitted to the extended reality device 140 over the communication link 150. In this manner, confidentiality and authenticity may be maintained for both request processing and response delivery in connection with the method 200.

One or more operations of FIG. 2 may be performed by hardware, firmware, software, or combinations thereof. In some embodiments, one or more operations of the method 200 may be carried out by executing program instructions on one or more processors of the computer system 110, the extended reality device 140, or another computing system. In some embodiments, one or more operations may be implemented by dedicated circuitry, programmable logic, one or more hardware accelerators, one or more software modules, one or more firmware modules, or combinations thereof. Accordingly, the method 200 may be implemented using a variety of processing arrangements and execution environments.

One or more operations of the method 200 may be performed by different systems or by different combinations of systems. For example, the extended reality device 140 may perform one or more data-acquisition, preprocessing, or coordinate-determination operations, while the computer system 110 may perform one or more target-determination, registry-traversal, metadata-evaluation, response-selection, security, or response-generation operations. In some embodiments, one or more operations may be distributed across one or more servers, one or more edge devices, one or more client devices, one or more registry services, or other cooperating systems. In some embodiments, a first operation may be performed by one system and a subsequent operation may be performed by another system, or a given operation may be shared across multiple systems.

In some embodiments, the method 200 may be embodied in instructions stored on a tangible, non-transitory, machine-readable medium and executed by one or more data processing apparatuses. The instructions may, when executed, cause the one or more data processing apparatuses to perform one or more of the operations described with reference to FIG. 2. The tangible, non-transitory, machine-readable medium may include one or more memories, storage devices, or other machine-readable storage media on which the instructions are stored. The particular allocation of operations among devices, systems, instructions, and execution resources may vary across implementations.

These techniques may be used both with wearable stereoscopic displays, like augmented reality or virtual reality headsets, and with non-stereoscopic two-dimensional displays, like tablet computers, laptop computers, automobile windshield displays, mobile phones, and the like. Further, the techniques herein may be implemented with the approaches described in U.S. Provisional Patent Application No. 63/790,536, filed Apr. 17, 2025, titled AUTOMATED ADVERTISING INSURANCE AND RIGHTS MANAGEMENT FOR DIGITAL REAL ESTATE ADVERTISING; U.S. Provisional Patent Application No. 63/806,663, filed May 15, 2025, titled SEMANTIC RIGHTS ENFORCEMENT FOR EXTENDED REALITY; U.S. Provisional Patent Application No. 63/878,865, filed Sep. 9, 2025, titled BIOMETRIC-UNLOCKED PERSONAL DIGITAL RIGHTS FRAMEWORK; U.S. Provisional Patent Application No. 63/888,268, filed Sep. 16, 2025, titled SEGMENT-LEVEL CRYPTOGRAPHIC VERIFICATION OF ADAPTIVE STREAMING CONTENT; U.S. Provisional Patent Application No. 63/924,259, filed Nov. 24, 2025, titled ADAPTIVE COLLECTION PROTOCOL FOR CONTEXT-AWARE, PRIVACY-PRESERVING AR TELEMETRY AND DIGITAL RIGHTS ENFORCEMENT; U.S. Provisional Patent Application No. 63/990,881, filed Feb. 25, 2026, titled SYSTEM AND METHOD FOR DISTRIBUTED TRUST-STATE MANAGEMENT AND DETERMINISTIC CRYPTOGRAPHIC VERIFICATION; and U.S. Provisional Patent Application No. 64/041,522, filed Apr. 16, 2026, titled SYSTEMS AND METHODS FOR REGISTRATION, ENFORCEMENT, AND MONETIZATION OF HUMAN-CENTRIC DIGITAL RIGHTS, each filed by the same Applicant, the contents of which are hereby incorporated by reference.

Some approaches to coordinate-based XR content resolution may rely primarily on estimated gaze direction or device pose when associating a user session with a physical target. In some embodiments, such approaches may initiate coordinate resolution for objects or regions that fall generally along a line of sight even though those objects or regions are not actually visible from the user's current viewpoint. This may occur in dense physical environments in which multiple structures, surfaces, or other objects occupy similar angular directions while differing in depth or visibility. As a result, some approaches may issue requests for targets that are fully or partially occluded, may misassociate attention with an incorrect region, and may consume processing, memory, network, or rendering resources in response to targets that are not presently viewable.

In some embodiments, target qualification may include determining whether a candidate spatial target region is visible from a current user viewpoint before issuing or completing coordinate resolution. A world-space view vector may be determined from device position, device orientation, gaze direction, or combinations thereof, and that view vector may be evaluated against a spatial representation of the physical environment, such as a mesh, voxel representation, scene model, or depth-aware model. The evaluation may include ray intersection testing, bounding volume hierarchy traversal, depth-buffer comparison, graphics-pipeline occlusion analysis, visibility-score computation, or combinations thereof. One or more intervening objects may thereby be detected between the user viewpoint and a candidate region, and the candidate region may be classified as visible, partially visible, or occluded. In some embodiments, coordinate resolution may be suppressed, deferred, or modified when a candidate region is determined to be occluded or insufficiently visible, thereby causing downstream registry traversal and response generation to operate on a refined set of candidate targets.

In some embodiments, the service may determine that a user is directing their gaze toward an occluded object by combining pose and gaze information from the XR device with a spatial model of the surrounding environment. The XR device may include sensors such as light detection and ranging (LiDAR) or stereoscopic depth cameras that generate a local mesh or voxel representation of the physical environment. Alternatively, or in addition, the system may reference a preexisting three-dimensional model of the city or area of interest. This model may be sourced from architectural records, photogrammetry, satellite data, or municipal digital twin infrastructure and may contain detailed mesh data annotated with semantic tags, object boundaries, and material properties. The model may be stored locally on the device or queried dynamically from a geospatial data service based on the user's current location.

In operation, the user's position and gaze direction may be combined to compute a world-space view vector originating at the estimated eye position. This vector may be tested against the geometry in the spatial model using ray casting, bounding volume hierarchy traversal, or other intersection algorithms to determine whether any objects lie between the user and a candidate content target. If the intersection point occurs before the target object's bounding volume is reached, the target may be classified as occluded. Some embodiments may perform these computations using a graphics pipeline–based occlusion pass, where the relevant portion of the city model is rendered from the user's viewpoint to a depth buffer, and the depth of each content object is then tested against that buffer.

As an example, a user walking near a city square may direct their gaze toward a historical monument that lies behind a newer structure. The device may detect from the user’s location and eye-tracked direction that their line of sight intersects the registered coordinate range associated with the monument. Before initiating a content resolution request, the system may query a local or cloud-based 3D model of the city that includes the newer building’s structure. By casting a ray from the user’s eye position toward the monument’s centroid and finding that it intersects the occluding building at a closer depth, the system may determine that the monument is not visible. In response, the device may suppress the content request for the monument, thereby avoiding unnecessary processing and bandwidth consumption.

In some embodiments, the system may also compute a visibility score based on the number of rays reaching the object from a sampling of points on the eye’s pupil or retina model, the percentage of the object’s screen-space area that is visible, or by tracing multiple rays across the object’s bounding volume. The visibility score may utilize a threshold to decide whether content resolution should proceed. In other embodiments, a persistent cache of per-region visibility data may be used, where the system tracks which objects are expected to be visible from various regions within the city, updating these estimates as the user moves. A developer may annotate objects in the 3D model with flags such as "only activate when fully visible" or "trigger content at partial view," allowing additional refinement in the occlusion determination logic.

Some approaches to location-associated XR content delivery may wait until a user has already arrived at a location or has already directed confirmed attention to a target before initiating coordinate resolution, endpoint retrieval, license retrieval, or related access operations. In moving sessions, such as pedestrian, cyclist, or vehicle sessions, this delayed initiation may cause content retrieval to begin only after a viewing opportunity has already narrowed, resulting in cold-start latency, shortened effective display windows, or missed presentation opportunities. These effects may be more pronounced where resolution depends on multiple upstream operations, such as registry lookup, rights-related evaluation, endpoint determination, authentication preparation, or remote content retrieval.

In some embodiments, the system may determine a predicted region of interest before confirmed arrival at or confirmed fixation on a future target. Position samples, orientation samples, gaze-direction samples, timestamps, and inertial measurements may be processed to determine a velocity vector, an acceleration profile, a predicted heading, a predicted attention direction, or a motion trajectory model over a sliding window of recent samples. Based on these data, a future spatial volume may be determined, such as a frustum, cone, corridor, curved volume, or other path-aligned extent extending from a current user position over a selected time horizon. One or more candidate coordinate ranges or target regions falling within the future spatial volume may then be identified for early processing, and the system may initiate coordinate resolution, endpoint determination, license retrieval, authentication preparation, preview retrieval, or local caching before the user directs confirmed attention to the future target. In some embodiments, provisional candidate entries may be invalidated, deprioritized, or refreshed when later movement, pose, or gaze data indicates that the projected path or attention state has changed.

In some embodiments, the service may initiate predictive content retrieval by extrapolating a user's future viewing direction and position based on their current movement and gaze patterns. The XR device may continuously sample positional and inertial data using onboard sensors such as GPS, accelerometers, gyroscopes, and magnetometers. From this data, a velocity vector may be derived that characterizes the user's direction and rate of movement in world coordinates. This velocity vector may be used in conjunction with a timestamped pose history to fit a motion trajectory model, such as a linear extrapolation or a higher-order polynomial curve fitted over a sliding window of recent positions.

In parallel, the user's head orientation and gaze vector may be sampled to determine whether the user is scanning in a consistent direction or focusing within a particular angular sector. When the system detects that the user is persistently walking toward or gazing along a particular heading, a predictive region-of-interest may be defined in front of the user's current position. This region may take the form of a frustum, cone, or curved volume extending along the predicted path, sized based on estimated walking speed and a configurable time horizon, such as one to five seconds into the future.

Within this predicted region, the system may query the Dynamic Geospatial DNS DRM service to identify coordinate ranges associated with upcoming content objects. The registry may return metadata describing each content endpoint, including digital rights status, provider identification, and associated geographic boundaries. The XR device may then prefetch content endpoints, licenses, or authentication tokens associated with the anticipated locations, either by initiating a resolution query early or by beginning to download and locally cache lightweight or low-resolution versions of the content. Once the object enters the user’s actual gaze frustum, the device may use the prefetched data to rapidly render the full experience without latency typically associated with cold-start content resolution.

For example, a user walking north on a city street may have a current heading of approximately 10 degrees. Based on their speed and recent pose data, the system may predict that in three seconds they will be adjacent to a building at a specific coordinate range. If that coordinate is mapped to an XR application endpoint with a valid license, the system may initiate an early resolution query. The prefetched data may include preview overlays or interactive elements that are ready for immediate activation when the user turns their gaze toward the building. If the predicted path diverges—for example, if the user turns into a side street or stops moving—the provisional candidate entries may be invalidated or deprioritized in a background queue to conserve resources.

Some embodiments may further refine predictions by incorporating map topology data, such as known walkable paths, building outlines, and common user flows derived from prior anonymized movement data. By integrating this context, the system may bias predictions toward likely navigation paths and eliminate content associated with areas that are physically inaccessible or out of view. Additional heuristics may include user interaction history, time-of-day patterns, and gaze stability metrics to distinguish between deliberate walking trajectories and incidental movement. Developers may configure their applications to indicate whether their content supports predictive preloading and whether specific content elements require confirmed visibility before activation.

Some approaches to coordinate-based resolution may process requests in a strictly serial manner, may wait for complete certainty before beginning lookup activity, or may establish a new secure transport session for each coordinate-resolution request. In systems that receive rapidly changing gaze data, pose data, or predicted movement data, such request handling may increase perceived latency, particularly where multiple adjacent or overlapping candidate regions remain plausible. In addition, some approaches may defer security handling until after target selection or may treat transport security as a separate concern from resolver behavior, which can add overhead to the resolution path or leave request contents exposed to intermediate processing stages before integrity or authenticity has been confirmed.

In some embodiments, resolver-side handling may be adapted to both reduce latency and secure request processing within the coordinate-resolution pipeline itself. The system may maintain multiple established secure communication sessions and may select among those sessions based on coordinate affinity, latency, load, or session validity rather than establishing a new secure session for each request. Where gaze data, pose data, or predicted movement data indicates ambiguity among multiple candidate coordinate ranges, the system may issue speculative parallel queries for adjacent or overlapping regions, may receive preliminary results in parallel, and may select one or more results for continued processing while discarding or deprioritizing others. In some embodiments, the system may provide a partial response or speculative response that includes reduced metadata, preview data, provider-identification data, resource-classification data, or authentication-related data while omitting endpoint data pending later confirmation. In some embodiments, an edge device or edge node may determine a provisional mapping between a spatial target region and at least one candidate entry using cached registry data or a model trained to approximate registry behavior, and an authoritative registry result may later confirm, replace, or update that provisional mapping. In some embodiments, the request payload may be received in encrypted form together with an encrypted session key, the session key may be decrypted using a private key of the resolver, the request payload may be decrypted using the recovered session key, and a digital signature associated with the request may be validated before downstream coordinate processing proceeds. Likewise, response data may be encrypted and digitally signed before transmission. In this manner, both latency-reduction behavior and cryptographic handling may be integrated into the resolver’s operational pipeline rather than treated as separate after-the-fact functions.

In some embodiments, additional techniques may be used to expedite coordinate-based lookups in the Dynamic Geospatial DNS DRM service beyond those already described, which include caching, hierarchical indexing, and anycast-based distribution. These additional techniques may involve prediction-based caching, connection pooling, speculative parallel queries, and use of local edge inference.

Prediction-based caching may operate by maintaining a local cache on the XR device or associated mobile device that is populated not only with results of recently accessed coordinate-to-endpoint mappings but also with mappings that are likely to be needed in the near future. The cache population strategy may use prediction models trained on user movement patterns, gaze behavior, and environmental context to preload mappings for nearby coordinates. These models may be implemented as Markov chains, time-series models, or neural networks that output a ranked list of likely next coordinates based on recent query sequences. This approach may reduce latency by ensuring relevant mappings are available locally before the user issues a formal resolution request.

Connection pooling may be applied to the secure communication channels between the XR device and the distributed Geospatial DNS service. Instead of establishing a new Transport Layer Security (TLS) or similar cryptographic session for each coordinate query, the device may maintain a persistent pool of pre-negotiated secure connections to different edge servers. When a new resolution request is needed, it may be assigned to one of these existing connections, thereby avoiding the overhead associated with repeated key exchanges and session establishment. In some configurations, the pool may be distributed across different network paths to account for varying latency and availability.

Speculative parallel queries may also be used to reduce perceived lookup time. When the user’s pose or gaze data is ambiguous—such as when the user is at an intersection or glancing rapidly between multiple buildings—the system may initiate parallel resolution requests for multiple adjacent or overlapping coordinate ranges. Once additional pose data becomes available, the device may select the appropriate result from among the speculative responses and discard or deprioritize the others. To reduce load, speculative queries may request partial responses, such as metadata only, omitting content or license blobs until a result is confirmed as relevant.

Local edge inference may be implemented by deploying compact models on the device or at a nearby network edge node that can perform limited inference on coordinate mappings without querying the central registry. These models may be trained to approximate the behavior of the registry in mapping a set of input coordinates to content provider IDs and DRM metadata. While not authoritative, such models may provide sufficiently accurate predictions to initiate content prefetching or UI transitions, pending confirmation from the full registry. In some embodiments, periodic delta updates to the model weights or rule sets may be pushed to the device to maintain alignment with the current registry.

Additional acceleration may be achieved by integrating content-aware pre-resolution, wherein coordinate ranges in the registry are annotated with common XR content themes or categories. If a user has a known preference or subscription profile (e.g., sports overlays, historical content, advertising opt-outs), the device may use this profile to selectively resolve only endpoints matching that content class, reducing resolution scope and filtering unnecessary queries. These filters may be executed client-side or pushed down to the geospatial resolver as query parameters, narrowing the lookup to a subset of endpoints.

Each of these approaches may be combined with the geospatial resolver’s TTL-based caching and hierarchical lookup structure, providing multiple layers of latency reduction adaptable to varying device capabilities, bandwidth conditions, and user behavior.

In some embodiments, the extended reality device may periodically retrieve a certificate revocation list (CRL) from the computer system 110 or another platform service. The CRL may contain identifiers of previously valid licenses or certificates that have been revoked due to suspension, expiration, policy violation, or other conditions. When the extended reality device attempts to serve cached content or use a cached license, the device may check the cached license against the CRL before rendering the associated content. If the license or certificate identifier appears on the CRL, the device may deny or halt content rendering, thereby enforcing revocation status locally without requiring a live connection to the geospatial resolver at the time of content access. In some embodiments, the extended reality device may store the most recently retrieved CRL locally, such that revocation enforcement may continue even when network connectivity is temporarily unavailable. When connectivity is restored, the device may fetch an updated CRL to ensure that revocation status remains current. This CRL-based approach may provide ongoing revocation support while allowing the device to operate with reduced latency and offline capability for content that remains validly licensed.

Some approaches to gaze-based spatial targeting may treat a direction of gaze alone as sufficient to determine a target location within a physical environment. In environments containing multiple objects or surfaces aligned along a similar angular direction, however, gaze direction by itself may be insufficient to distinguish which of several depth-separated candidates is the intended point of attention. In addition, some approaches may initiate coordinate resolution in response to transient glances, saccadic motion, or unstable attention states that do not correspond to deliberate user engagement with a target. As a result, a system may issue requests for an incorrect depth plane, an incorrect object, or an incidental line-of-sight intersection rather than a user-intended target.

In some embodiments, gaze qualification may include determining a gaze ray in world coordinates and determining a focal-depth estimate associated with user attention before initiating or finalizing coordinate resolution. Head pose, eye-tracking data, and optical calibration data may be combined to construct a gaze ray extending from an estimated eye position through a point of fixation, and vergence information may be used to determine a focal depth at which the user’s visual attention is concentrated. The gaze ray may be intersected with a depth-aware model of the physical environment, and a focal depth associated with user gaze may be compared to a depth associated with a candidate object or candidate region. In some embodiments, a candidate target may be selected only when the focal depth matches the target depth within a threshold. In some embodiments, successive gaze samples may be analyzed to determine whether a fixation condition, dwell threshold, gaze-stability condition, or combinations thereof are satisfied before the corresponding coordinate is treated as a valid target. By jointly using direction, depth, and temporal fixation information, the system may distinguish among multiple depth-separated candidates along a similar line of sight and may reduce coordinate-resolution requests caused by incidental or insufficiently stable gaze events.

In some embodiments, the system may integrate gaze tracking and varifocal capabilities of XR devices to enhance the accuracy and contextual relevance of geospatial coordinate resolution. Gaze tracking modules may provide a continuously updated three-dimensional gaze vector, including both direction and eye convergence distance, allowing the system to infer not only where the user is looking but also the depth at which their visual attention is focused. Varifocal XR devices may further include dynamically adjustable lenses or display planes that shift optical focus based on estimated focal distance, facilitating a more accurate correlation between user attention and real-world spatial coordinates.

The XR device may combine head pose, eye tracking data, and optical calibration to construct a gaze ray in world coordinates, extending from the user's eye through a point of fixation. If the XR system includes a vergence measurement capability, it may also compute the depth at which both eyes converge, producing a scalar focal distance estimate. By intersecting the gaze ray with a depth-aware model of the environment—such as a locally generated mesh or a referenced three-dimensional city model—the system may determine a more precise point of interest in space. This focal point may be used as the basis for a coordinate resolution request, allowing the system to distinguish between, for example, a user looking at a window on the third floor of a building versus the sidewalk in front of the same structure.

Some embodiments may incorporate temporal gaze stability into the triggering logic for initiating coordinate-based resource resolution. A fixation detection algorithm may monitor the gaze vector over time, determining whether a fixation criterion has been satisfied based on whether the user has looked at a particular region within the environment for more than a dwell-time threshold. This threshold may be measured in milliseconds and may vary based on context, such as whether the user is moving or stationary. For example, the system may require a gaze lock of at least 300 milliseconds on a valid coordinate target before initiating a request to the Dynamic Geospatial DNS DRM service. This thresholding may reduce spurious content fetches due to incidental glances or saccadic eye motion.

In some embodiments, gaze depth and dwell time may be used jointly. For instance, the system may restrict content resolution to gaze targets whose estimated focal depth is within a defined tolerance of the depth of a known coordinate-mapped object. If the user is looking toward a region but is focusing at a depth significantly different from that of the object, the system may infer that the attention is not directed at that object and may suppress the corresponding request. Conversely, if the gaze direction aligns with the object’s bounding box and the focal depth closely matches the object's physical location, and the dwell time exceeds the configured threshold, the system may trigger the resolution process.

Additionally, some embodiments may support variable dwell time thresholds based on content type or developer-defined sensitivity levels. For example, interactive elements may require a shorter dwell time to engage, while licensed video content may require a longer, more deliberate fixation before initiating playback. The XR device may also adjust lens focus or rendering depth-of-field in response to inferred gaze depth, further reinforcing the user’s perception of spatial alignment between gaze, content, and the physical environment. The system may log gaze events and corresponding resolution requests for later analysis or optimization, allowing developers to refine the trigger logic based on real-world usage patterns.

In some embodiments, user velocity may be incorporated as a gating parameter for initiating coordinate resolution requests to the Dynamic Geospatial DNS DRM service. Velocity data, obtained from GPS, inertial sensors, or vehicle systems, may be used to estimate how long a user is likely to remain within viewing range of a given coordinate-mapped region. If this estimated exposure time falls below a predefined threshold, the system may suppress or defer resolution, particularly when content is time-sensitive, requires sustained attention, or involves high-bandwidth retrieval.

For instance, if a user is traveling in a car at high speed and glances in the direction of a building with registered XR content, the system may determine that the viewing opportunity is too brief to justify initiating a full resolution and content retrieval cycle. The resolution logic may factor in both the user’s velocity vector and the size and orientation of the geospatial region, projecting the expected window of visibility and filtering out content not viable within that window.

Some embodiments may allow developers to define velocity-dependent resolution rules for specific content types, such as minimum viewing time, required angular exposure, or motion class (e.g., pedestrian, cyclist, vehicle). In other configurations, the system may allow metadata-only queries at high speeds for analytics or content preloading without triggering full content rendering or DRM checks. Velocity-based suppression may also be combined with gaze stability and predictive motion modeling to further refine which resolution requests are issued under dynamic conditions.

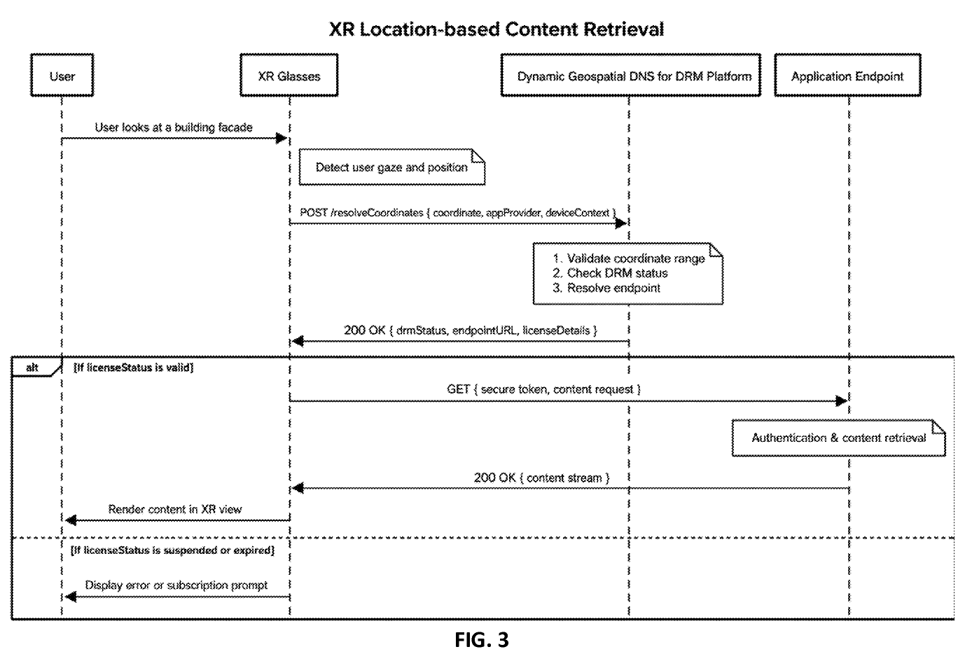

FIG. 3 is a sequence diagram illustrating an example flow for location-based content retrieval in an extended reality environment. The diagram depicts interactions among four participants: a User, XR Glasses, a Dynamic Geospatial DNS for DRM Platform, and an Application Endpoint. The sequence may begin when the user looks at a building facade or other physical target. The XR Glasses may detect user gaze and position information associated with the user's attention direction. Based on the detected gaze and position, the XR Glasses may transmit a POST resolveCoordinates request to the Dynamic Geospatial DNS for DRM Platform. The request may include parameters such as coordinate data, an application provider identifier (appProvider), and device context information (deviceContext).

Upon receiving the request, the Dynamic Geospatial DNS for DRM Platform may perform one or more operations including validating the coordinate range, checking DRM status associated with the coordinate range, and resolving an appropriate endpoint. After completing these operations, the platform may return a 200 OK response to the XR Glasses. The response may include DRM status information (drmStatus), an endpoint URL (endpointURL), and license details (licenseDetails) associated with the resolved coordinate range.

The sequence may then proceed along an alternative path based on the license status. In some embodiments, when the license status is valid, the XR Glasses may transmit a GET request to the Application Endpoint. The GET request may include a secure token and a content request. The Application Endpoint may perform authentication and content retrieval operations and may return a 200 OK response including a content stream. The XR Glasses may then render the content in the XR view for presentation to the user. In some embodiments, when the license status indicates a suspended or expired state, the XR Glasses may instead display an error message or a subscription prompt to the user without proceeding to content retrieval from the Application Endpoint.

The particular sequence of operations, message formats, response contents, and participant roles shown in FIG. 3 are illustrative. In some embodiments, additional operations may be performed, one or more illustrated operations may be omitted or reordered, and one or more participants may be combined, subdivided, or replaced with other components. The diagram is provided as one example of a flow for location-based content retrieval and is not intended to limit the scope of the described techniques.

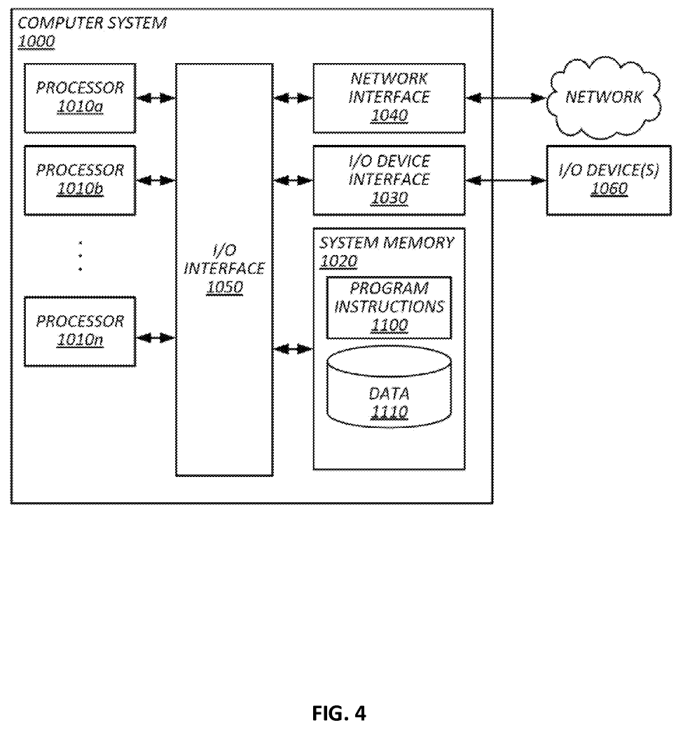

FIG. 4 is a diagram that illustrates an exemplary computing system 1000 in accordance with embodiments of the present technique. The devices and systems herein may be implemented with components like that shown. A single computing device is shown, but some embodiments of a computer system may include multiple computing devices that communicate over a network, for instance in the course of collectively executing various parts of a distributed application. Various portions of systems and methods described herein may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some embodiments, the entire set of instructions may be stored concurrently on the media, or in some embodiments, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some embodiments, notwithstanding use of the singular term "medium," the instructions may be distributed on different storage devices associated with different computing devices, for instance, with each computing device having a different subset of the instructions, an implementation consistent with usage of the singular term “medium” herein. In some embodiments, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some embodiments, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or "a element" includes a combination of two or more elements, notwithstanding use of other terms and phrases for one or more elements, such as “one or more.” The term "or" is, unless indicated otherwise, non-exclusive, i.e., encompassing both "and" and "or." Terms describing conditional relationships, e.g., "in response to X, Y," "upon X, Y,", “if X, Y,” "when X, Y," and the like, encompass causal relationships in which the antecedent is a necessary causal condition, the described with reference to geometric constructs, like "parallel," "perpendicular/orthogonal," “square”, “cylindrical,” and the like, should be construed as encompassing items that substantially embody the properties of the geometric construct, e.g., reference to "parallel" surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms "first", "second", "third," “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence. antecedent is a sufficient causal condition, or the antecedent is a contributory causal condition of the consequent, e.g., "state X occurs upon condition Y obtaining" is generic to "X occurs solely upon Y" and "X occurs upon Y and Z." Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X’ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:
1. A method including: obtaining a set of geospatial coordinates based on at least one of user gaze data and pose data, the at least one of user gaze data and pose data being obtained from an extended reality device; determining, with a computing device, a spatial target region in a physical environment based on the geospatial coordinates; determining, with the computing device, one or more candidate entries of a hierarchical geospatial registry based on the spatial target region, wherein the hierarchical geospatial registry is configured to store entries associated with respective coordinate ranges or spatial regions, corresponding endpoint data, and metadata specifying at least one of license status, expiration data, geographic restriction data, provider status, user-context constraints, or device-context constraints; determining, with the computing device, based on at least one of the license status, the expiration data, the geographic restriction data, the provider status, the user-context constraints, or the device-context constraints associated with the one or more candidate entries, that providing endpoint data associated with at least one of the one or more candidate entries to the extended reality device is permitted; and providing, with the computing device, at least one of endpoint data, license data, authentication data, preview data, or reduced metadata associated with the one or more candidate entries to the extended reality device.
2. The method of embodiment 1, wherein determining a spatial target region further comprises: obtaining, from the extended reality device, a sequence of position samples, orientation samples, gaze-direction samples, and inertial measurements for a user session; determining, from the sequence of position samples and the inertial measurements, a velocity vector and an acceleration profile; determining, from the sequence of orientation samples and the gaze-direction samples, a predicted heading and a predicted attention direction; determining a motion trajectory model over a sliding window of the sequence of position samples, orientation samples, and gaze-direction samples; determining, from the motion trajectory model, a future spatial volume extending from a current user position in accordance with the predicted heading, the predicted attention direction, and a time horizon; and determining the spatial target region from the future spatial volume.
3. The method of embodiment 1, wherein the operations further comprise: determining, with the computing device, that the spatial target region is visible from a user viewpoint by: determining a world-space view vector based on a position and an orientation of the extended reality device; evaluating a model of the physical environment using at least one of ray intersection testing, bounding volume hierarchy traversal, or depth-buffer comparison; determining whether one or more intervening objects are positioned between the user viewpoint and the spatial target region; and determining that the spatial target region is visible in response to determining that the one or more intervening objects do not occlude the spatial target region.
4. The method of embodiment 1, wherein determining the one or more candidate entries of the hierarchical geospatial registry further comprises recursively traversing parent region entries and child region entries of the hierarchical geospatial registry beginning at a root region entry and descending through increasingly localized region entries based on whether the spatial target region falls within coordinate ranges associated with the parent region entries and the child region entries until the one or more candidate entries associated with the spatial target region are identified.
5. The method of embodiment 1, wherein the operations further comprise: maintaining, with the computing device, a plurality of secure communication sessions for coordinate-resolution requests, wherein each secure communication session has been established before receipt of a current request to determine the one or more candidate entries; selecting, with the computing device, one of the secure communication sessions based on at least one of a coordinate range associated with the spatial target region, a latency metric, a load metric, or a session validity metric; and transmitting, with the computing device, a request associated with the spatial target region over the selected secure communication session.
6. The method of embodiment 5, wherein each secure communication session is associated with a session key and a remote resolver endpoint.
7. The method of embodiment 1, wherein determining the one or more candidate entries of the hierarchical geospatial registry further comprises: in response to ambiguity in the at least one of user gaze data and pose data, identifying a plurality of adjacent or overlapping candidate coordinate ranges associated with the spatial target region; transmitting a plurality of coordinate-resolution requests concurrently for the plurality of adjacent or overlapping candidate coordinate ranges; receiving a plurality of respective results corresponding to the plurality of coordinate-resolution requests; evaluating the plurality of respective results based on the spatial target region; and selecting at least one of the plurality of respective results for determining the one or more candidate entries.
8. The method of embodiment 1, wherein determining the one or more candidate entries of the hierarchical geospatial registry further comprises: determining, with an edge computing device, a provisional mapping between the spatial target region and at least one candidate entry using at least one of cached registry data or a model trained to approximate registry mappings; selecting response data associated with the provisional mapping for transmission to the extended reality device; receiving an authoritative registry result for the spatial target region; and determining whether to confirm, replace, or update the provisional mapping based on the authoritative registry result.
9. The method of embodiment 1, wherein the endpoint data comprises a network-accessible resource configured to provide digital content for rendering an extended reality output associated with the spatial target region to the extended reality device.
10. The method of embodiment 1, wherein obtaining the set of geospatial coordinates further comprises: determining a focal depth associated with user gaze based on vergence information from the extended reality device; and determining that the set of geospatial coordinates corresponds to a target object in response to determining that the focal depth is within a threshold distance of a depth associated with the target object.
11. The method of embodiment 1, wherein providing at least one of the endpoint data, the license data, the authentication data, the preview data, or the reduced metadata further comprises providing a speculative response including reduced metadata associated with the one or more candidate entries before determining whether endpoint data associated with at least one of the one or more candidate entries is to be provided to the extended reality device.
12. The method of embodiment 1, wherein providing at least one of the endpoint data, the license data, the authentication data, the preview data, or the reduced metadata further comprises providing a partial response, the partial response including, for at least one of the one or more candidate entries, at least one of preview data, provider-identification data, candidate-entry metadata, content-type data, resource-classification data, or authentication-related metadata, and excluding the endpoint data.
13. The method of embodiment 1, wherein obtaining the set of geospatial coordinates further comprises: receiving, from the extended reality device, an encrypted request payload and an encrypted session key; decrypting the encrypted session key; and decrypting the encrypted request payload using the decrypted session key.
14. The method of embodiment 13, wherein obtaining the set of geospatial coordinates further comprises: validating a digital signature associated with the encrypted request payload, wherein providing at least one of the endpoint data, the license data, the authentication data, the preview data, or the reduced metadata further comprises encrypting a response payload and generating a digital signature for the response payload before transmitting the response payload to the extended reality device.
15. The method of embodiment 1, wherein obtaining the set of geospatial coordinates further comprises iteratively monitoring gaze data over time during a user session, determining a plurality of successive gaze samples, and repeatedly updating the set of geospatial coordinates based on changes among the plurality of successive gaze samples.
16. The method of embodiment 15, wherein repeatedly updating the set of geospatial coordinates further comprises: determining whether the plurality of successive gaze samples satisfies a dwell-time threshold; and updating the set of geospatial coordinates in response to determining that the dwell-time threshold is satisfied.
17. The method of embodiment 1, wherein the extended reality device comprises a head-mounted display or smart glasses, the head-mounted display or smart glasses including one or more outward-facing cameras.
18. The method of embodiment 1, wherein obtaining the set of geospatial coordinates further comprises: receiving, from a head-mounted extended reality device, a stream of image frames, a stream of inertial measurements, and a stream of gaze samples; temporally aligning the stream of image frames, the stream of inertial measurements, and the stream of gaze samples; and determining the set of geospatial coordinates based on the temporally aligned stream of image frames, the stream of inertial measurements, and the stream of gaze samples.
19. A tangible, non-transitory, machine-readable medium storing instructions that when executed by a data processing apparatus cause the data processing apparatus to perform operations including: the operations of any one of embodiments 1-18.
20. A system, including: one or more processors; and memory storing instructions that when executed by the processors cause the processors to effectuate operations including: the operations of any one of embodiments 1-18.

What is claimed is:

1. A tangible, non-transitory, machine-readable medium storing instructions that when executed by a data processing apparatus cause the data processing apparatus to perform operations comprising:
obtaining a set of geospatial coordinates based on at least one of user gaze data and pose data, the at least one of user gaze data and pose data being obtained from an extended reality device;
determining, with a computing device, a spatial target region in a physical environment based on the geospatial coordinates;
determining, with the computing device, one or more candidate entries of a hierarchical geospatial registry based on the spatial target region, wherein the hierarchical geospatial registry is configured to store entries associated with respective coordinate ranges or spatial regions, corresponding endpoint data, and metadata specifying at least one of license status, suspension reason, expiration data, geographic restriction data, provider status, user-context constraints, or device-context constraints;
determining, with the computing device, based on at least one of the license status, the suspension reason, the expiration data, the geographic restriction data, the provider status, the user-context constraints, or the device-context constraints associated with the one or more candidate entries, that providing endpoint data associated with at least one of the one or more candidate entries to the extended reality device is permitted; and
providing, with the computing device, at least one of endpoint data, license data, authentication data, preview data, or reduced metadata associated with the one or more candidate entries to at least one of the extended reality device or a server configured to provide content to the extended reality device.

2. The medium of claim 1, wherein determining a spatial target region further comprises:
obtaining, from the extended reality device, a sequence of position samples, orientation samples, gaze-direction samples, and inertial measurements for a user session;
determining, from the sequence of position samples and the inertial measurements, a velocity vector and an acceleration profile;
determining, from the sequence of orientation samples and the gaze-direction samples, a predicted heading and a predicted attention direction;
determining a motion trajectory model over a sliding window of the sequence of position samples, orientation samples, and gaze-direction samples;
determining, from the motion trajectory model, a future spatial volume extending from a current user position in accordance with the predicted heading, the predicted attention direction, and a time horizon; and
determining the spatial target region from the future spatial volume.

3. The medium of claim 1, wherein the operations further comprise:
determining, with the computing device, that the spatial target region is visible from a user viewpoint by:
determining a world-space view vector based on a position and an orientation of the extended reality device;
evaluating a model of the physical environment using at least one of ray intersection testing, bounding volume hierarchy traversal, or depth-buffer comparison;
determining whether one or more intervening objects are positioned between the user viewpoint and the spatial target region; and
determining that the spatial target region is visible in response to determining that the one or more intervening objects do not occlude the spatial target region.

4. The medium of claim 1, wherein determining the one or more candidate entries of the hierarchical geospatial registry further comprises recursively traversing parent region entries and child region entries of the hierarchical geospatial registry beginning at a root region entry and descending through increasingly localized region entries based on whether the spatial target region falls within coordinate ranges associated with the parent region entries and the child region entries until the one or more candidate entries associated with the spatial target region are identified.

5. The medium of claim 1, wherein the operations further comprise:
maintaining, with the computing device, a plurality of secure communication sessions for coordinate-resolution requests, wherein each secure communication session has been established before receipt of a current request to determine the one or more candidate entries;
selecting, with the computing device, one of the secure communication sessions based on at least one of a coordinate range associated with the spatial target region, a latency metric, a load metric, or a session validity metric; and
transmitting, with the computing device, a request associated with the spatial target region over the selected secure communication session

6. The medium of claim 5, wherein each secure communication session is associated with a session key and a remote resolver endpoint.

7. The medium of claim 1, wherein determining the one or more candidate entries of the hierarchical geospatial registry further comprises:
in response to ambiguity in the at least one of user gaze data and pose data, identifying a plurality of adjacent or overlapping candidate coordinate ranges associated with the spatial target region;
transmitting a plurality of coordinate-resolution requests concurrently for the plurality of adjacent or overlapping candidate coordinate ranges;
receiving a plurality of respective results corresponding to the plurality of coordinate-resolution requests;
evaluating the plurality of respective results based on the spatial target region; and
selecting at least one of the plurality of respective results for determining the one or more candidate entries.

8. The medium of claim 1, wherein determining the one or more candidate entries of the hierarchical geospatial registry further comprises:
determining, with an edge computing device, a provisional mapping between the spatial target region and at least one candidate entry using at least one of cached registry data or a model trained to approximate registry mappings;
selecting response data associated with the provisional mapping for transmission to the extended reality device;
receiving an authoritative registry result for the spatial target region; and
determining whether to confirm, replace, or update the provisional mapping based on the authoritative registry result.

9. The medium of claim 1, wherein the endpoint data comprises a network-accessible resource configured to provide digital content for rendering an extended reality output associated with the spatial target region to the extended reality device.

10. The medium of claim 1, wherein obtaining the set of geospatial coordinates further comprises:
determining a focal depth associated with user gaze based on vergence information from the extended reality device; and
determining that the set of geospatial coordinates corresponds to a target object in response to determining that the focal depth is within a threshold distance of a depth associated with the target object.

11. The medium of claim 1, wherein providing at least one of the endpoint data, the license data, the authentication data, the preview data, or the reduced metadata further comprises providing a speculative response comprising reduced metadata associated with the one or more candidate entries before determining whether endpoint data associated with at least one of the one or more candidate entries is to be provided to the extended reality device.

12. The medium of claim 1, wherein providing at least one of the endpoint data, the license data, the authentication data, the preview data, or the reduced metadata further comprises providing a partial response, the partial response comprising, for at least one of the one or more candidate entries, at least one of preview data, provider-identification data, candidate-entry metadata, content-type data, resource-classification data, or authentication-related metadata, and excluding the endpoint data.

13. The medium of claim 1, wherein obtaining the set of geospatial coordinates further comprises:
receiving, from the extended reality device, an encrypted request payload and an encrypted session key;
decrypting the encrypted session key; and
decrypting the encrypted request payload using the decrypted session key.

14. The medium of claim 13, wherein obtaining the set of geospatial coordinates further comprises: validating a digital signature associated with the encrypted request payload, wherein providing at least one of the endpoint data, the license data, the authentication data, the preview data, or the reduced metadata further comprises encrypting a response payload and generating a digital signature for the response payload before transmitting the response payload to the extended reality device.

15. The medium of claim 1, wherein obtaining the set of geospatial coordinates further comprises iteratively monitoring gaze data over time during a user session, determining a plurality of successive gaze samples, and repeatedly updating the set of geospatial coordinates based on changes among the plurality of successive gaze samples.

16. The medium of claim 15, wherein repeatedly updating the set of geospatial coordinates further comprises:
determining whether the plurality of successive gaze samples satisfies a dwell-time threshold; and
updating the set of geospatial coordinates in response to determining that the dwell-time threshold is satisfied.

17. The medium of claim 1, wherein the extended reality device comprises a head-mounted display or smart glasses, the head-mounted display or smart glasses comprising one or more outward-facing cameras.

18. The medium of claim 1, wherein obtaining the set of geospatial coordinates further comprises:
receiving, from a head-mounted extended reality device, a stream of image frames, a stream of inertial measurements, and a stream of gaze samples;
temporally aligning the stream of image frames, the stream of inertial measurements, and the stream of gaze samples; and
determining the set of geospatial coordinates based on the temporally aligned stream of image frames, the stream of inertial measurements, and the stream of gaze samples.

19. The medium of claim 1, wherein determining a spatial target region comprises steps for determining a spatial target region.

20. A method comprising:
obtaining a set of geospatial coordinates based on at least one of user gaze data and pose data, the at least one of user gaze data and pose data being obtained from an extended reality device;
determining, with a computing device, a spatial target region in a physical environment based on the geospatial coordinates;
determining, with the computing device, one or more candidate entries of a hierarchical geospatial registry based on the spatial target region, wherein the hierarchical geospatial registry is configured to store entries associated with respective coordinate ranges or spatial regions, corresponding endpoint data, and metadata specifying at least one of license status, suspension reason, expiration data, geographic restriction data, provider status, user-context constraints, or device-context constraints;
determining, with the computing device, based on at least one of the license status, the suspension reason, the expiration data, the geographic restriction data, the provider status, the user-context constraints, or the device-context constraints associated with the one or more candidate entries, that providing endpoint data associated with at least one of the one or more candidate entries to the extended reality device is permitted; and
providing, with the computing device, at least one of endpoint data, license data, authentication data, preview data, or reduced metadata associated with the one or more candidate entries to at least one of the extended reality device or a server configured to provide content to the extended reality device.
